(19) United States
(12) Patent Application Publication
(10) Pub. No.: US 2018/0297272 A1
(43) Pub. Date: Oct. 18, 2018

(54) HIGH DENSITY 3D PRINTING

(71) Applicant: Desktop Metal, Inc., Burlington, MA (US)

(72) Inventors: Aaron Preston, Arlington, MA (US); Nicholas Mykulowycz, Boxford, MA (US); Alexander C. Barbati, Cambridge, MA (US); Michael A. Gibson, Burlington, MA (US); Charles John Haider, Burlington, MA (US); Jay Tobia, Cambridge, MA (US)

(21) Appl. No.: 15/953,380

(22) Filed: Apr. 13, 2018

Related U.S. Application Data
(60) Provisional application No. 62/485,604, filed on Apr. 14, 2017.
(60) Provisional application No. 62/611,181, filed on Dec. 28, 2017.

(51) Int. Cl. B29C 64/118; B29C 64/209; B29C 64/393; B33Y 10/00; B33Y 50/02

(52) U.S. Cl. CPC B29C 64/118; B29C 64/209; B33Y 50/02; B33Y 10/00; B29C 64/393

(57) ABSTRACT

Methods of printing an object via a 3-dimensional printer include provide for printed objects having a higher density. A printer head is operated to deposit build material in lines under controlled parameters including lateral position, height, extrustion rate, extrusion temperature, and/or extrusion material. The printer may print first lines forming channels at a given layer, and then second lines to fill those channels. The printer may operate with other approaches to fill gaps between printed lines, such as offset and/or smaller lines aligned with those gaps. The resulting object has greater density while maintaining an accurate object shape.

### RELATED APPLICATIONS

This application claims the benefit of U.S. Provisional Application No. 62/485,604, filed on Apr. 14, 2017, and U.S. Provisional Application No. 62/611,181, filed on Dec. 28, 2017. The entire teachings of the above applications are incorporated herein by reference.

### BACKGROUND

Metal injection molding (MIM) is a metalworking process useful in creating a variety of metal objects. A mixture of powdered metal and binder (e.g., a polymer such as polypropylene) forms a “feedstock” capable of being molded, at a high temperature, into the shape of a desired object. The initial molded part, also referred to as a “green part,” then undergoes a debinding process to remove the binder, followed by a sintering process. During sintering, the part is brought to a temperature near the melting point of the powdered metal, which evaporates any remaining binder and forming the metal powder into a solid mass, thereby producing the desired object.

Additive manufacturing, also referred to as 3D printing, includes a variety of techniques for manufacturing a three-dimensional object via an automated process of forming successive layers of the object. 3D printers may utilize a feedstock comparable to that used in MIM, thereby creating a green part without the need for a mold. The green part may then undergo comparable debinding and sintering processes to produce the object.

### SUMMARY

Example embodiments include a method of printing an object. Strands of build material may be printed at a controlled rate of effluence from a print head as the print head moves at a speed and direction relative to a build surface. A first set of strands of a build material may be deposited at a set of strand-widths and strand-heights, a local print direction defining the local strand position and being substantially locally parallel between adjacently deposited strands of the first set, gaps between the first set of strands having a set of gap widths. A second set of filler strands of the build material may be deposited, the second set of filler strands deposited with a second set of filler strand-heights, and having a second set of filler strand-widths sufficiently wide to cause the second set of filler strands of the build material to substantially fill the gaps between the first set of strands.

The plurality of the first set of strands of build material may be deposited at a first temperature of the build material, and depositing the second set of filler strands of the build material at a second temperature of the build material different than the first temperature of the build material. The plurality of the first set of parallel strands of build material may be deposited at a first ratio of a rate of effluence to the product of the strand width and strand height and relative speed, and the plurality of the second set of filler strands may be deposited at a second ratio of a rate of effluence to the product of the strand width and strand height and relative speed, wherein the ratio for the first set of parallel strands is substantially different than the ratio for the second set of filler strands. The plurality of the first set of parallel strands of build material may be deposited at a first speed relative to the build surface, and depositing the plurality of the second set of filler strands at a second speed relative to the build surface, where the second speed relative to the build surface is substantially different than the first speed relative to the build surface.

The first set of parallel strands of build material may be deposited at a first strand width, and the second set of filler strands of the build material may be deposited at a second strand width, where the first strand width is substantially different than the first strand width. The plurality of the first set of parallel strands of build material may be deposited at a first strand height, and the second set of filler strands of the build material may be deposited at a second strand height, where the first strand height is substantially different than the first strand height. The first set of strand heights and second set of strand heights may be substantially equal. Each of the set of second strand widths may be approximately equal to the width of corresponding gap in which each second strand is deposited. The widths of the set of second strand widths may be within 5% of the widths of the gaps. The widths of the set of second strand widths may be within 1% of the widths of the gaps.

Further embodiments may include a method of printing an object, where strands of build material are printed at a controlled rate of effluence from a print head that moves at a speed and direction relative to a build surface. A first plurality of substantially locally parallel strands may be printed from a build material in a first layer of a printed object, the plurality of strands positioned adjacent to one another and having a first set of strand widths. A second plurality of substantially locally parallel strands may be printed from the build material in a second layer of the printed object, each of the strands from the second plurality of strands covering from above a connection point between two of the first plurality of strands. An edge strand may be printed in an adjacent layer, the edge strand occupying an edge portion of the adjacent layer of the object, the edge line having a width substantially larger than the uniform width of each of the second plurality of parallel lines. An edge strandline may be printed in an adjacent layer, the edge strand occupying an edge portion of the adjacent layer of the object, the edge line having a width substantially smaller than the uniform width of each of the second plurality of parallel lines. The uniform width of the second plurality of strands is less than the uniform width of the first plurality of strands. A third plurality of strands may be printed in a third layer of the printed object, a vertical distance between the first and second layer being distinct from the vertical distance between the second and third layer.

A further embodiment may include a method of printing an object, where strands of build material are printed at a controlled rate of effluence from a print head that moves at a speed and direction relative to a build surface, said strands of a build material exhibiting a predetermined set of strand-widths and strand-heights. A first layer of a printed object may be printed at a first ratio of the rate of effluence to the product of the build speed and strand height and strand width. A second layer of a printed object may be printed at a second ratio of the rate of effluence to the product of the build speed and strand height and strand width, the second ratio being greater than the first ratio. Accumulation of build material may be determined at a print head concurrently with printing the second layer and compared against a threshold. The build material may then be removed from the print head in response to the accumulation surpassing the threshold.

Still further embodiments may include a method of printing an object, where material is deposited from a print head at a deposition rate, the deposition rate selected to yield a controllable accumulation of material on the print head during the deposition process. Accumulation of build material at a print head may be determined concurrently with material deposition and compared against a threshold. The build material may then be removed from the print head in response to the accumulation surpassing the threshold.

A further embodiment may include a method of printing an object, where strands of build material are deposited at a controlled rate of effluence from a print head that moves at a speed and direction relative to a build surface. A first layer of an object may be printed from a plurality of first strands having a strand width and strand height, the first layer having a first height equal to the first strand height, the first layer having a first extrusion ratio given by a first rate of effluence over the product of the first deposition speed and first strand height and first strand width. A second layer of the object may be printed from a plurality of second strands having a second strand width and second strand height, the second layer having a second extrusion ratio given by the second rate of effluence over the product of the second deposition speed and second strand height and second strand width, the second layer having a second height equal to the second strand height.

The first and second layers may be printed at an equal extrusion ratio. The second layer may be printed by printing the plurality of second strands such that the vectors describing the first and second strands are substantially offset from one another in the plane of the layering axis. The second layer may be printed at a second extrusion ratio less than the first extrusion ratio. The second layer may be printed such that lines of the second layer are centered on edges of printed lines of the first layer.

Further example embodiments include a method of printing an object. A plurality of lines may be printed in parallel from a build material at a first layer of a printed object, where plurality of parallel lines form at least one channel within the first layer. The build material may then be printed into the at least one channel, the printing causing the build material to expand into a volume within a z-projection of the plurality of parallel lines. The plurality of parallel lines may be printed at a first temperature of the build material, and the build material may be printed into the at least one channel at a second temperature being greater than the first temperature. The plurality of parallel lines may be printed at a first deposition rate, and printing the build material into the at least one channel at a second deposition rate being greater than the first deposition rate.

Further embodiments may include a method of printing an object, where a first plurality of parallel lines are printed from a build material in a first layer of a printed object, the plurality of lines being positioned adjacent to one another and having a uniform width. A second plurality of parallel lines may be printed from the build material in a second layer of the printed object, the plurality of lines having a uniform width and being centered above a connection point between two of the first plurality of lines. An edge line may be printed in the second layer, the edge line occupying an edge portion of the second layer of the object, the edge line having a width greater than the uniform width of each of the second plurality of parallel lines. The uniform width of the second plurality of parallel lines may be less than the uniform width of the first plurality of parallel lines. A third plurality of parallel lines may be printed in a third layer of the printed object, a vertical distance between the first and second layer being distinct from the vertical distance between the second and third layer.

Further embodiments may include a method of printing an object, where a first layer of a printed object is printed at a first deposition rate. A second layer of a printed object is printed at a second deposition rate being greater than the first deposition rate. Accumulation of build material is detected or determined at a print head concurrently with printing the second layer. The accumulation may be compared against a threshold, and the build material may be removed from the print head in response to the accumulation surpassing the threshold.

Further embodiments may include a method of printing an object, where a plurality of offset lines from a build material are printed at a first layer of a printed object, the plurality of offset lines forming at least one channel within the first layer. The build material may be printed into the at least one channel, the printing causing the build material to expand into a volume within a z-projection of the plurality of offset lines. The plurality of offset lines may be printed at a first temperature of the build material, and printing the build material into the at least one channel at a second temperature being distinct from the first temperature. The first temperature may be lower than the second temperature. The plurality of offset lines may be printed at a first deposition rate, and the build material may be printed into the at least one channel at a second deposition rate being greater than the first deposition rate. The plurality offset lines may be deposited at a first track width, and the build material printed into the at least one channel is deposited at a second track width distinct from the first track width. The first track width may be greater than the second track width. The plurality of offset lines may be a first plurality of offset lines, and the printing the build material into the at least one channel may form a second plurality of offset lines interspersed between the first plurality of offset lines. The second plurality of offset lines may include a bottom layer and a top layer, the top layer being printed independent of the bottom layer. Printing the build material may include overextruding the material into the channel during a first duration and decreasing the extrusion rate following the first duration. Prior to printing the build material into the at least one channel, additional offset lines may be printed in at least one layer above the first layer, the additional offset lines being aligned in a z-projection to the offset lines.

Further embodiments may include a method of printing an object where a first layer of an object is printed, the first layer having a first height. A second layer of the object may be printed having a second height distinct from the first height. The first and second layers may be printed at an equal extrusion rate. The second layer may be printed to have a z-projection offset relative to the first layer. The second layer may be printed at a flow rate less than a flow rate at which the first layer is printed. Lines of the second layer may be printed centered on edges of printed lines of the first layer.

### BRIEF DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1 is a block diagram of an additive manufacturing system.

FIG. 2 is a flow chart of a method for printing with composites.

FIG. 3 illustrates an additive manufacturing system for use with metal injection molding materials.

FIG. 4 is an isometric cross-section view of two layers printed by a 3D printer in an example embodiment.

FIG. 5 is a front-cross section view of line deposition in different configurations.

FIG. 6 illustrates an example print in a further embodiment.

FIG. 7 illustrates an example print in a still further embodiment.

FIG. 8 illustrates an example print in a yet further embodiment.

FIGS. 9A-B are top-down views of a set of toolpaths that may be implemented in one embodiment.

FIG. 10 is a side and top-down view of an in-process deposition of a line.

FIG. 11 is a cross-section of a print in a further embodiment.

FIG. 12 is a cross-section illustrating printed lines at varying extrusion rates.

FIG. 13 is a top-down view of a set of toolpaths in an example embodiment.

FIG. 14 is a side view of a deposition in an example embodiment.

FIG. 15 illustrates a print in a further example embodiment.

FIG. 16 illustrates a print in a further embodiment.

FIG. 17 illustrates a print in a still further embodiment.

FIG. 18 is a timing diagram illustrating operation of a printer in example embodiments.

FIG. 19 illustrates a cross-section of a print in a further embodiment.

FIG. 20 illustrates a method of printing to provide a compressed infill line within a channel.

### DETAILED DESCRIPTION OF THE INVENTION

A description of example embodiments follows.

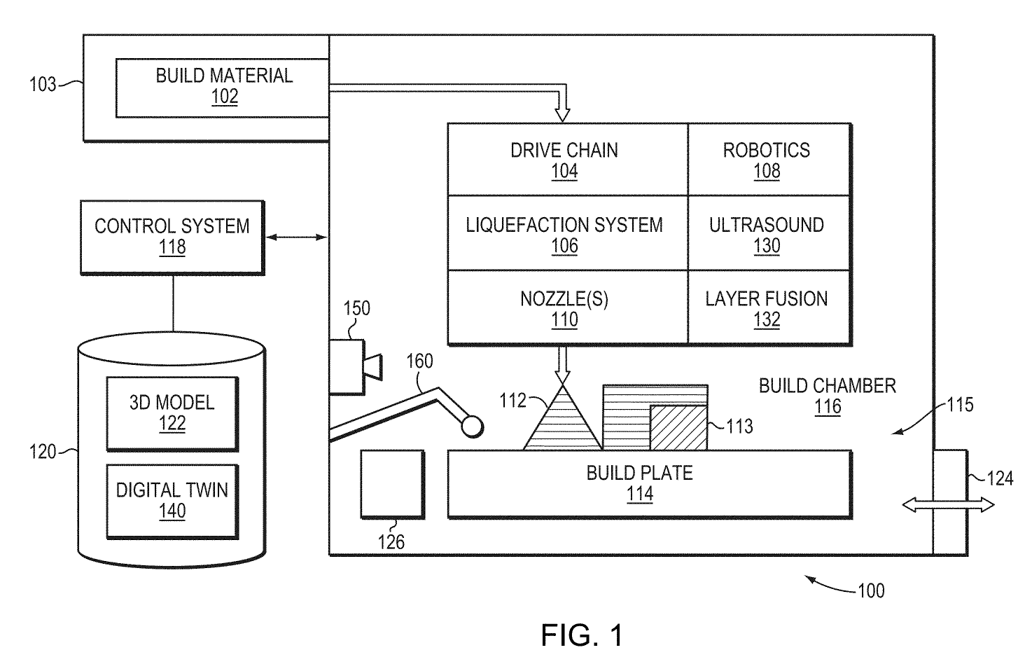

FIG. 1 is a block diagram of an additive manufacturing system for use with composites, and that may be implemented in example embodiments. The additive manufacturing system may include a three-dimensional printer 100 (or simply printer 100) that deposits metal using fused filament fabrication. Fused filament fabrication is well known in the art, and may be usefully employed for additive manufacturing with suitable adaptations to accommodate the forces, temperatures and other environmental requirements typical of the metallic injection molding materials described herein. In general, the printer 100 may include a build material 102 that is propelled by a drive train 104 and heated to a workable state by a liquefaction system 106, and then dispensed through one or more nozzles 110. By concurrently controlling robotic system 108 to position the nozzle(s) along an extrusion path, an object 112 (also referred to as a part) may be fabricated on a build plate 114 within a build chamber 116. In general, a control system 118 manages operation of the printer 100 to fabricate the object 112 according to a three-dimensional model using a fused filament fabrication process or the like.

A variety of commercially available compositions have been engineered for metal injection molding (“MIM”). These highly engineered materials can also be adapted for use as a build material 102 in printing techniques such as fused filament fabrication. For example, MIM feedstock materials, when suitably shaped, may be usefully extruded through nozzles typical of commercially available FFF machines, and are generally flowable or extrudable within typical operating temperatures (e.g., 160-250 degrees Celsius) of such machines. This temperature range may depend on the binder—e.g., some binders achieve appropriate viscosities at about 205 degrees Celsius, while others achieve appropriate viscosities at lower temperatures such as about 160-180 C degrees Celsius. One of ordinary skill will recognize that these ranges (and all ranges listed herein) are provided by way of example and not of limitation. Further, while there are no formal limits on the dimensions for powder metallurgy materials, parts with dimensions of around 100 millimeters on each side have been demonstrated to perform well for FFF fabrication of net shape green bodies. Any smaller dimensions may be usefully employed, and larger dimensions may also be employed provided they are consistent with processing dimensions such as the print resolution and the extrusion orifice diameter. For example, implementations target about a 0.300 μm diameter extrusion, and the MIM metal powder may typically be about 122 μm diameter, although nano sized powders can be used. The term metal injection molding material, as used herein, may include any such engineered materials, as well as other fine powder bases such as ceramics in a similar binder suitable for injection molding. Thus, where the term metal injection molding or the commonly used abbreviation, MIM, is used, the term may include injection molding materials using powders other than, or in addition to, metals and, thus, may include ceramics. Also, any reference to “MIM materials,” “powder metallurgy materials,” “MIM feedstocks,” or the like may generally refer to metal powder and/or ceramic powder mixed with one or more binding materials, e.g., a backbone binder that holds everything together and a bulk binder that carries the metal and backbone into position within a mold or print. Other material systems may be suitable for fabricating metal parts using fabrication techniques such as stereolithography or binder jetting, some of which are discussed in greater detail below. Such fabrication techniques may, in some applications, be identical to techniques for fabricating parts from ceramic material.

In general, fabrication of such materials may proceed as with a conventional FFF process, except that after the net shape is created, the green part may be optionally machined or finished while in a more easily workable state, and then debound and sintered into a final, dense object using any of the methods common in the art for MIM materials. The final object, as described above, may include a metal, a metal alloy, a ceramic, or another suitable combination of materials.

The build material 102 may be fed from a carrier 103 configured to dispense the build material to the three-dimensional printer either in a continuous (e.g., wire) or discrete (e.g., billet) form. The build material 102 may for example be supplied in discrete units one by one as billets or the like into an intermediate chamber for delivery into the build chamber 118 and subsequent melt and deposition. The carrier 103 may include a spool or cartridge containing the build material 102 in a wire form. Where a vacuum or other controlled environment is desired, the wire may be fed through a vacuum gasket into the build chamber 118 in a continuous fashion, however, typical MIM materials can be heated to a workable plastic state under normal atmospheric conditions, except perhaps for filtering or the like to remove particles from the build chamber 116. Thus, a MIM build material may be formed into a wire, the build material including an engineered composite of metal powder and a polymeric binder or the like, wherein the carrier 103 is configured to dispense the build material in a continuous feed to a three-dimensional printer. For environmentally sensitive materials, the carrier 103 may provide a vacuum environment for the build material 102 that can be directly or indirectly coupled to the vacuum environment of the build chamber 118. More generally, the build chamber 118 (and the carrier 103) may maintain any suitably inert environment for handling of the build material 102, such as a vacuum, and oxygen-depleted environment, an inert gas environment, or some gas or combination of gasses that are not reactive with the build material 102 where such conditions are necessary or beneficial during three-dimensional fabrication.

A drive train 104 may include any suitable gears, compression pistons, or the like for continuous or indexed feeding of the build material 116 into the liquefaction system 106. The drive train 104 may include gear shaped to mesh with corresponding features in the build material such as ridges, notches, or other positive or negative detents. The drive train 104 may use heated gears or screw mechanisms to deform and engage with the build material. Thus, a printer for a fused filament fabrication process can heats a build material to a working temperature, and that heats a gear that engages with, deforms, and drives the composite in a feed path. A screw feed may also or instead be used.

For more brittle MIM materials, a fine-toothed drive gear of a material such as a hard resin or plastic may be used to grip the material without excessive cutting or stress concentrations that might otherwise crack, strip, or otherwise compromise the build material.

The drive train 104 may use bellows, or any other collapsible or telescoping press to drive rods, billets, or similar units of build material into the liquefaction system 106. Similarly, a piezoelectric or linear stepper drive may be used to advance a unit of build media in a non-continuous, stepped method with discrete, high-powered mechanical increments. Further, the drive train 104 may include multiple stages. In a first stage, the drive train 104 may heat the composite material and form threads or other features that can supply positive gripping traction into the material. In the next stage, a gear or the like matching these features can be used to advance the build material along the feed path. A collet feed may be used (e.g., similar to those on a mechanical pencil). A soft wheel or belt drive may also or instead be used. A shape forming wheel drive may be used to ensure accuracy of size and thus the build. More generally, the drive train 104 may include any mechanism or combination of mechanisms used to advance build material 102 for deposition in a three-dimensional fabrication process.

The liquefaction system 106 may be any liquefaction system configured to heat the composite to a working temperature in a range suitable for extrusion in a fused filament fabrication process. Any number of heating techniques may be used. Electrical techniques such as inductive or resistive heating may be usefully applied to liquefy the build material 102. This may, for example include inductively or resistively heating a chamber around the build material 102 to a temperature at or near the glass transition temperature of the build material 102, or some other temperature where the binder or other matrix becomes workable, extrudable, or flowable for deposition as described herein. Where the contemplated build materials are sufficiently conductive, they may be directly heated through contact methods (e.g., resistive heating with applied current) or non-contact methods (e.g., induction heating using an external electromagnet to drive eddy currents within the material). The choice of additives may further be advantageously selected to provide bulk electrical characteristics (e.g., conductance/resistivity) to improve heating. When directly heating the build material 102, it may be useful to model the shape and size of the build material 102 in order to better control electrically-induced heating. This may include estimates or actual measurements of shape, size, mass, etc.

In the above context, “liquefaction” does not require complete liquefaction. That is, the media to be used in printing may be in a multi-phase state, and/or form a paste or the like having highly viscous and/or non-Newtonian fluid properties. Thus the liquefaction system 106 may include, more generally, any system that places a build material 102 in condition for use in fabrication.

In order to facilitate resistive heating of the build material 102, one or more contact pads, probes or the like may be positioned within the feed path for the material in order to provide locations for forming a circuit through the material at the appropriate location(s). In order to facilitate induction heating, one or more electromagnets may be positioned at suitable locations adjacent to the feed path and operated, e.g., by the control system 118, to heat the build material internally through the creation of eddy currents. Both of these techniques may be used concurrently to achieve a more tightly controlled or more evenly distributed electrical heating within the build material. The printer 100 may also be instrumented to monitor the resulting heating in a variety of ways. For example, the printer 100 may monitor power delivered to the inductive or resistive circuits. The printer 100 may also or instead measure temperature of the build material 102 or surrounding environment at any number of locations. The temperature of the build material 102 may be inferred by measuring, e.g., the amount of force required to drive the build material 102 through a nozzle 110 or other portion of the feed path, which may be used as a proxy for the viscosity of the build material 102. More generally, any techniques suitable for measuring temperature or viscosity of the build material 102 and responsively controlling applied electrical energy may be used to control liquefaction for a fabrication process using composites as described herein.

The liquefaction system 106 may also or instead include any other heating systems suitable for applying heat to the build material 102 to a suitable temperature for extrusion. This may, for example include techniques for locally or globally augmenting heating using, e.g., chemical heating, combustion, ultrasound heating, laser heating, electron beam heating or other optical or mechanical heating techniques and so forth.

The liquefaction system 106 may include a shearing engine. The shearing engine may create shear within the composite as it is heated in order to maintain a mixture of the metallic base and a binder or other matrix, or to maintain a mixture of various materials in a paste or other build material. A variety of techniques may be employed by the shearing engine. The bulk media may be axially rotated as it is fed along the feed path into the liquefaction system 106. Further, one or more ultrasonic transducers may be used to introduce shear within the heated material. Similarly, a screw, post, arm, or other physical element may be placed within the heated media and rotated or otherwise actuated to mix the heated material. Bulk build material may include individual pellets, rods, or coils (e.g., of consistent size) and fed into a screw, a plunger, a rod extruder, or the like. For example, a coiled build material can be uncoiled with a heater system including a heated box, heated tube, or heater from the printer head. Also, a direct feed with no heat that feeds right into the print head is also possible.

The robotic system 108 may include a robotic system configured to three-dimensionally position the nozzle 110 within the working volume 115 of the build chamber 116. This may, for example, include any robotic components or systems suitable for positioning the nozzle 110 relative to the build plate 114 while depositing the composite in a pattern to fabricate the object 112. A variety of robotics systems are known in the art and suitable for use as the robotic system 108 described herein. For example, the robotics may include a Cartesian or xy-z robotics system employing a number of linear controls to move independently in the x-axis, the y-axis, and the z-axis within the build chamber 116. Delta robots may also or instead be usefully employed, which can, if properly configured, provide significant advantages in terms of speed and stiffness, as well as offering the design convenience of fixed motors or drive elements. Other configurations such as double or triple delta robots can increase range of motion using multiple linkages. More generally, any robotics suitable for controlled positioning of the nozzle 110 relative to the build plate 114, especially within a vacuum or similar environment, may be usefully employed including any mechanism or combination of mechanisms suitable for actuation, manipulation, locomotion and the like within the build chamber 116.

The nozzle(s) 110 may include one or more nozzles for dispensing the build material 102 that has been propelled with the drive train 104 and heated with the liquefaction system 106 to a suitable working temperature. In a multiphase extrusion this may include a working temperature above the melting temperature of the metallic base of the composite, or more specifically between a first temperature at which the metallic base melts and the second temperature (above the first temperature) at which a second phase of the composite remains inert.

The nozzles 110 may, for example, be used to dispense different types of material so that, for example, one nozzle 110 dispenses a composite build material while another nozzle 110 dispenses a support material in order to support bridges, overhangs, and other structural features of the object 112 that would otherwise violate design rules for fabrication with the composite build material. Further, one of the nozzles 110 may deposit a different type of material, such as a thermally compatible polymer or a metal or polymer loaded with fibers of one or more materials to increase tensile strength or otherwise improve mechanical properties of the resulting object 112. Two types of supports may be used—(1) build supports and (2) sinter supports—e.g., using different materials printed into the same part to achieve these supports, or to create a distinguishing junction between these supports and the part.

The nozzle 110 may preferably be formed of a material or combination of materials with suitable mechanical and thermal properties. For example, the nozzle 110 will preferably not degrade at the temperatures wherein the composite material is to be dispensed, or due to the passage of metallic particles through a dispensing orifice therein. While nozzles for traditional polymer-based fused filament fabrication may be made from brass or aluminum alloys, a nozzle that dispenses metal particles may be formed of harder materials, or materials compatible with more elevated working temperatures such as a high carbon steel that is hardened and tempered. Other materials such as a refractory metal (e.g. molybdenum, tungsten) or refractory ceramic (e.g. mullite, corundum, magnesia) may also or instead be employed. In some instances, aluminum nozzles may instead be used for MIM extrusion of certain MIM materials. Further, a softer thermally conductive material with a hard, wear-resistant coating may be used, such as copper with a hard nickel plating.

The nozzle 110 may include one or more ultrasound transducers 130 as described herein. Ultrasound may be usefully applied for a variety of purposes in this context. The ultrasound energy may facilitate extrusion by mitigating clogging by reducing adhesion of a build material to an interior surface of the nozzle 110. A variety of energy director techniques may be used to improve this general approach. For example, a deposited layer may include one or more ridges, which may be imposed by an exit shape of the nozzle 110, to present a focused area to receive ultrasound energy introduced into the interface between the deposited layer and an adjacent layer.

The nozzle 110 may include an induction heating element, resistive heating element, or similar components to directly control the temperature of the nozzle 110. This may be used to augment a more general liquefaction process along the feed path through the printer 100, e.g., to maintain a temperature of the build material 102 during fabrication, or this may be used for more specific functions, such as declogging a print head by heating the build material 102 substantially above the working range, e.g., to a temperature where the composite is liquid. While it may be difficult or impossible to control deposition in this liquid state, the heating can provide a convenient technique to reset the nozzle 110 without more severe physical intervention such as removing vacuum to disassemble, clean, and replace the affected components.

The nozzle 110 may include an inlet gas or fan, e.g., an inert gas, to cool media at the moment it exits the nozzle 110. The resulting gas jet may, for example, immediately stiffen the dispensed material to facilitate extended bridging, larger overhangs, or other structures that might otherwise require support structures underneath.

The object 112 may be any object suitable for fabrication using the techniques described herein. This may include functional objects such as machine parts, aesthetic objects such as sculptures, or any other type of objects, as well as combinations of objects that can be fit within the physical constraints of the build chamber 116 and build plate 114. Some structures such as large bridges and overhangs cannot be fabricated directly using fused filament fabrication or the like because there is no underlying physical surface onto which a material can be deposited. In these instances, a support structure 113 may be fabricated, preferably of a soluble or otherwise readily removable material, in order to support the corresponding feature.

Where multiple nozzles 110 are provided, a second nozzle may usefully provide any of a variety of additional build materials. This may, for example, include other composites, alloys, bulk metallic glass's, thermally matched polymers and so forth to support fabrication of suitable support structures. One of the nozzles 110 may dispense a bulk metallic glass that is deposited at one temperature to fabricate a support structure 113, and a second, higher temperature at an interface to a printed object 112 where the bulk metallic glass can be crystallized at the interface to become more brittle and facilitate mechanical removal of the support structure 113 from the object 112. Conveniently, the bulk form of the support structure 113 can be left in the super-cooled state so that it can retain its bulk structure and be removed in a single piece. Thus, a printer may fabricate a portion of a support structure 113 with a bulk metallic glass in a super-cooled liquid region, and may fabricate a layer of the support structure adjacent to a printed object at a greater temperature in order to crystalize the build material 102 into a non-amorphous alloy. The bulk metallic glass particles may thus be loaded into a MIM feedstock binder system and may provide a support. Pure binding or polymer materials (e.g., without any loading) may also or instead provide a support. A similar metal MIM feedstock may be used for multi-material part creation. Ceramic or dissimilar metal MIM feedstock may be used for a support interface material.

The build plate 114 within the working volume 115 of the build chamber 116 may include a rigid and substantially planar surface formed of any substance suitable for receiving deposited composite or other material(s)s from the nozzles 110. The build plate 114 may be heated, e.g., resistively or inductively, to control a temperature of the build chamber 116 or the surface upon which the object 112 is being fabricated. This may, for example, improve adhesion, prevent thermally induced deformation or failure, and facilitate relaxation of stresses within the fabricated object. Further, the build plate 114 may be a deformable build plate that can bend or otherwise physical deform in order to detach from the rigid object 112 formed thereon.

The build chamber 116 may be any chamber suitable for containing the build plate 114, an object 112, and any other components of the printer 100 used within the build chamber 116 to fabricate the object 112. The build chamber 116 may be an environmentally sealed chamber that can be evacuated with a vacuum pump 124 or similar device in order to provide a vacuum environment for fabrication. This may be particularly useful where oxygen causes a passivation layer that might weaken layer-to-layer bonds in a fused filament fabrication process as described herein, or where particles in the atmosphere might otherwise interfere with the integrity of a fabricated object, or where the build chamber 116 is the same as the sintering chamber. Alternatively, only oxygen may be removed from the build chamber 116.

Similarly, one or more passive or active oxygen getters 126 or other similar oxygen absorbing material or system may usefully be employed within the build chamber 116 to take up free oxygen within the build chamber 116. The oxygen getter 126 may, for example, include a deposit of a reactive material coating an inside surface of the build chamber 116 or a separate object placed therein that completes and maintains the vacuum by combining with or adsorbing residual gas molecules. The oxygen getters 126, or more generally, gas getters, may be deposited as a support material using one of the nozzles 110, which facilitates replacement of the gas getter with each new fabrication run and can advantageously position the gas getter(s) near printed media in order to more locally remove passivating gasses where new material is being deposited onto the fabricated object. The oxygen getters 126 may include any of a variety of materials that preferentially react with oxygen including, e.g., materials based on titanium, aluminum, and so forth. Further, the oxygen getters 126 may include a chemical energy source such as a combustible gas, gas torch, catalytic heater, Bunsen burner, or other chemical and/or combustion source that reacts to extract oxygen from the environment. There are a variety of low-CO and NOx catalytic burners that may be suitably employed for this purpose without CO.

The oxygen getter 126 may be deposited as a separate material during a build process. Thus, a three-dimensional object may be fabricated from a metallic composite, including a physically adjacent structure (which may or may not directly contact the three-dimensional object) fabricated to contain an agent to remove passivating gasses around the three-dimensional object. Other techniques may be similarly employed to control reactivity of the environment within the build chamber 116, or within post-processing chambers or the like as described below. For example, the build chamber 116 may be filled with an inert gas or the like to prevent oxidation.

The control system 118 may include a processor and memory, as well as any other co-processors, signal processors, inputs and outputs, digital-to-analog or analog-to-digital converters and other processing circuitry useful for monitoring and controlling a fabrication process executing on the printer 100. The control system 118 may be coupled in a communicating relationship with a supply of the build material 102, the drive train 104, the liquefaction system 106, the nozzles 110, the build plate 114, the robotic system 108, and any other instrumentation or control components associated with the build process such as temperature sensors, pressure sensors, oxygen sensors, vacuum pumps, and so forth. The control system 118 may be operable to control the robotic system 108, the liquefaction system 106 and other components to fabricate an object 112 from the build material 102 in three dimensions within the working volume 115 of the build chamber 116.

The control system 118 may generate machine ready code for execution by the printer 100 to fabricate the object 112 from the three-dimensional model 122 stored to a database 120. The control system 118 may deploy a number of strategies to improve the resulting physical object structurally or aesthetically. For example, the control system 118 may use plowing, ironing, planing, or similar techniques where the nozzle 110 runs over existing layers of deposited material, e.g., to level the material, remove passivation layers, apply an energy director topography of peaks or ridges to improve layer-to-layer bonding, or otherwise prepare the current layer for a next layer of material. The nozzle 110 may include a low-friction or non-stick surface such as Teflon, TiN or the like to facilitate this plowing process, and the nozzle 110 may be heated and/or vibrated (e.g., using an ultrasound transducer) to improve the smoothing effect. This surface preparation may be incorporated into the initially-generated machine ready code. Alternatively, the printer 100 may dynamically monitor deposited layers and determine, on a layer-bylayer basis, whether additional surface preparation is necessary or helpful for successful completion of the object.

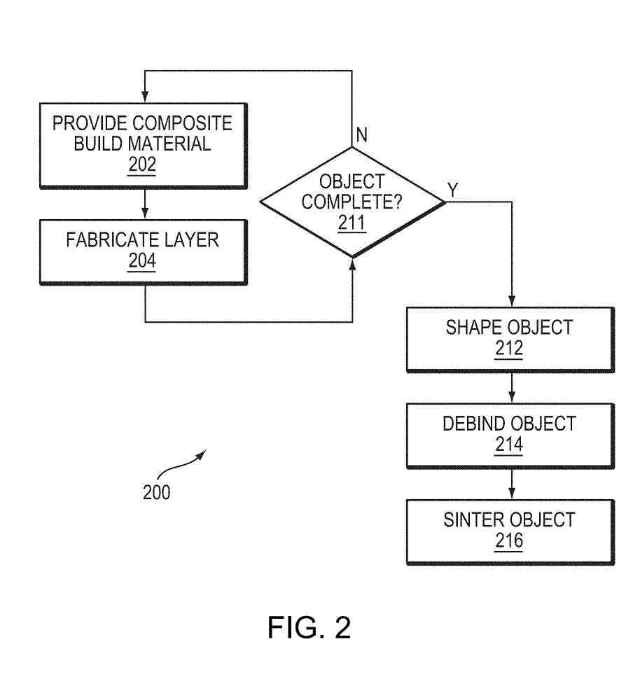

FIG. 2 shows a flow chart of a method for printing with composites, e.g., metal injection molding materials. As shown in step 202, the process 200 may include providing a build material including an injection molding material, or where a support interface is being fabricated, a MIM binder (e.g., a MIM binder with similar thermal characteristics). The material may include, for example, any of the MIM materials described herein. The material may be provided as a build material in a billet, a wire, or any other cast, drawn, extruded or otherwise shaped bulk form. As described above, the build material may be further packaged in a cartridge, spool, or other suitable carrier that can be attached to an additive manufacturing system for use.

As shown in step 204, the process may include fabricating a layer of an object. This may include any techniques that can be adapted for use with MIM materials. For example, this may include fused filament fabrication, jet printing or any other techniques for forming a net shape from a MIM material (and more specifically for techniques used for forming a net shape from a polymeric material loaded with a second phase powder).

As shown in step 211, this process may be continued and repeated as necessary to fabricate an object within the working volume. While the process may vary according to the underlying fabrication technology, an object can generally be fabricated layer by layer based on a three-dimensional model of the desired object. As shown in step 212, the process 200 may include shaping the net shape object after the additive process is complete. Before debinding or sintering, the green body form of the object is usefully in a soft, workable state where defects and printing artifacts can be easily removed, either manually or automatically. Thus the process 200 may take advantage of this workable, intermediate state to facilitate quality control or other process-related steps, such as removal of supports that are required for previous printing steps, but not for debinding or sintering.

As shown in step 214, the process 200 may include debinding the printed object. In general debinding may be performed chemically or thermally to remove a binder that retains a metal (or ceramic or other) powder in a net shape. Contemporary injection molding materials are often engineered for thermal debinding, which advantageously permits debinding and sintering to be performed in a single baking operation, or in two similar baking operations. In general, the debinding process functions to remove binder from the net shape green object, thus leaving a very dense structure of metal (or ceramic or other) particles that can be sintered into the final form.

As shown in step 216, the process 200 may include sintering the printed and debound object into a final form. In general, sintering may be any process of compacting and forming a solid mass of material by heating without liquefaction. During a sintering process, atoms can diffuse across particle boundaries to fuse into a solid piece. Because sintering can be performed at temperatures below the melting temperature, this advantageously permits fabrication with very high melting point materials such as tungsten and molybdenum.

Numerous sintering techniques are known in the art, and the selection of a particular technique may depend upon the build material used, and the desired structural, functional or aesthetic result for the fabricated object. For example, in solid-state (non-activated) sintering, metal powder particles are heated to form connections (or “necks”) where they are in contact. Over time, these necks thicken and create a dense part, leaving small, interstitial voids that can be closed, e.g., by hot isostatic pressing (HIP) or similar processes. Other techniques may also or instead be employed. For example, solid state activated sintering uses a film between powder particles to improve mobility of atoms between particles and accelerate the formation and thickening of necks. As another example, liquid phase sintering may be used, in which a liquid forms around metal particles. This can improve diffusion and joining between particles, but also may leave lower-melting phase within the sintered object that impairs structural integrity. Other advanced techniques such as nano-phase separation sintering may be used, for example to form a high-diffusivity solid at the necks to improve the transport of metal atoms at the contact point

Debinding and sintering may result in material loss and compaction, and the resulting object may be significantly smaller than the printed object. However, these effects are generally linear in the aggregate, and net shape objects can be usefully scaled up when printing to create a corresponding shape after debinding and sintering.

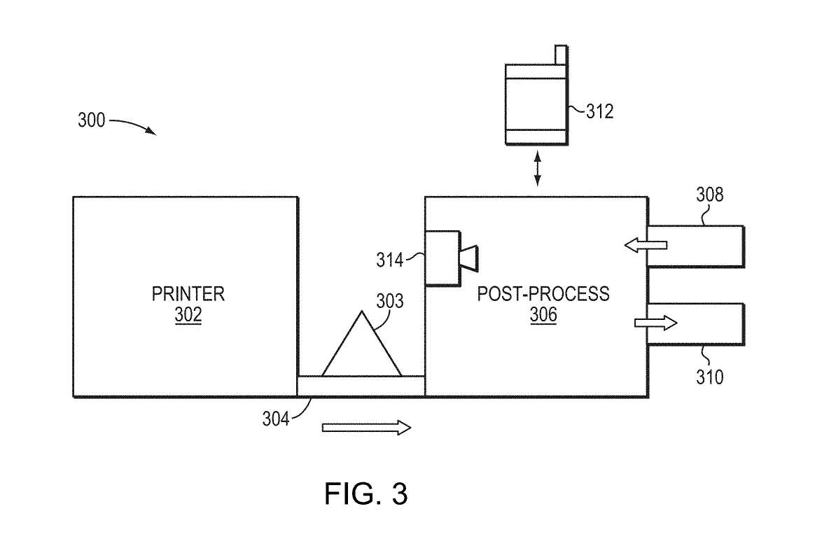

FIG. 3 shows an additive manufacturing system for use with metal injection molding materials. The system 300 may include a printer 302, a conveyor 304, and a postprocessing station 306. In general, the printer 302 may be any of the printers described above including, for example a fused filament fabrication system, a stereolithography system, a selective laser sintering system, or any other system that can be usefully adapted to form a net shape object under computer control using injection molding build materials. The output of the printer 302 may be an object 303 that is a green body including any suitable powder (e.g., metal, metal alloy, ceramic, and so forth, as well as combinations of the foregoing), along with a binder that retains the powder in a net shape produced by the printer 302.

The conveyor 304 may be used to transport the object 303 from the printer 302 to a post-processing station 306 where debinding and sintering can be performed. The conveyor 304 may be any suitable device or combination of devices suitable for physically transporting the object 303. This may, for example, include robotics and a machine vision system or the like on the printer side for detaching the object 303 from a build platform or the like, as well as robotics and a machine vision system or the like on the post-processing side to accurately place the object 303 within the post-processing station 306. Further, the post-processing station 306 may serve multiple printers so that a number of objects can be debound and sintered concurrently, and the conveyor 304 may interconnect the printers and post-processing station so that multiple print jobs can be coordinated and automatically completed in parallel. Alternatively, the object 303 may be manually transported between the two corresponding stations.

The post-processing station 306 may be any system or combination of systems useful for converting a green part formed into a desired net shape from a metal injection molding build material by the printer 302 into a final object. The post-processing station 306 may, for example, include a chemical debinding station and a thermal sintering station that can be used in sequence to produce a final object. Some contemporary injection molding materials are engineered for thermal debinding, which makes it possible to perform a combination of debinding and sintering steps with a single oven or similar device. While the thermal specifications of a sintering furnace may depend upon the powder to be sintered, the binder system, the loading, and other properties of the green object and the materials used to manufacture same, commercial sintering furnaces for thermally debound and sintered MIM parts may typically operate with an accuracy of +/−5 degrees Celsius or better, and temperatures of at least 600 degrees C., or from about 200 degrees C. to about 1900 degrees C. for extended times. Any such furnace or similar heating device may be usefully employed as the post-processing station 306 as described herein. Vacuum or pressure treatment may also or instead be used. Identical or similar material beads with a non-binding coating may be used for a furnace support—e.g., packing in a bed of this material that shrinks similar to the part, except that it will not bond to the part.

Embodiments may be implemented with a wide range of other debinding and sintering processes. For example, the binder may be removed in a chemical debind, thermal debind, or some combination of these. Other debinding processes are also known in the art (such as supercritical or catalytic debinding), any of which may also or instead be employed by the post-processing station 306 as described herein. For example, in a common process, a green part is first debound using a chemical debind, which is following by a thermal debind at a moderately high temperature (in this context, around 700-800 C) to remove organic binder and create enough necks among a powdered material to permit handling. From this stage, the object may be moved to a sintering furnace to remove any remaining components of a binder system densify the object. Alternatively, a pure thermal debind may be used to remove the organic binder. More general, any technique or combination of techniques may be usefully employed to debind an object as described herein.

Similarly, a wide range of sintering techniques may be usefully employed by the post-processing station. For example, an object may be consolidated in a furnace to a high theoretical density using vacuum sintering. Alternatively, the furnace may use a combination of flowing gas (e.g., at below atmosphere, slightly above atmosphere, or some other suitable pressure) and vacuum sintering. More generally, any sintering or other process suitable for improving object density may be used, preferably where the process yields a near-theoretical density part with little or no porosity. Hot-isostatic pressing (“HIP”) may also (e.g., as a post sinter finishing step) or instead be employed, e.g., by applying elevated temperatures and pressures of 10-50 ksi, or between about 15 and 30 ksi. Alternatively, the object may be processed using any of the foregoing, followed by a moderate overpressure (greater than the sintering pressure, but lower than HIP pressures). In this latter process, gas may be pressurized at 100-1500 psi and maintained at elevated temperatures within the furnace or some other supplemental chamber. Alternatively, the object may be separately heated in one furnace, and then immersed in a hot granular media inside a die, with pressure applied to the media so that it can be transmitted to the object to drive more rapid consolidation to near full density. More generally, any technique or combination of techniques suitable for removing binder systems and driving a powdered material toward consolidation and densification may be used by the post-processing station 306 to process a fabricated green part as described herein.

The post-processing station 306 may be incorporated into the printer 302, thus removing a need for a conveyor 304 to physically transport the object 303. The build volume of the printer 302 and components therein may be fabricated to withstand the elevated debinding/sintering temperatures. Alternatively, the printer 302 may provide movable walls, barriers, or other enclosure(s) within the build volume so that the debind/sinter can be performed while the object 303 is on a build platform within the printer 302, but thermally isolated from any thermally sensitive components or materials.

The post-processing station 306 may be optimized in a variety of ways for use in an office environment. The post-processing station 306 may include an inert gas source 308. The inert gas source 308 may, for example, include argon or other inert gas (or other gas that is inert to the sintered material), and may be housed in a removable and replaceable cartridge that can be coupled to the post-processing station 306 for discharge into the interior of the post-processing station 306, and then removed and replaced when the contents are exhausted. The post-processing station 306 may also or instead include a filter 310 such as a charcoal filter or the like for exhausting gasses that can be outgassed into an office environment in an unfiltered form. For other gasses, an exterior exhaust, or a gas container or the like may be provided to permit use in unventilated areas. For reclaimable materials, a closed system may also or instead be used, particularly where the environmental materials are expensive or dangerous.

The post-processing station 306 may be coupled to other system components. For example, the post-processing station 306 may include information from the printer 302, or from a controller for the printer, about the geometry, size, mass and other physical characteristics of the object 303 in order to generate a suitable debinding and sintering profile. Optionally, the profile may be created independently by the controller or other resource and transmitted to the post-processing station 306 when the object 303 is conveyed. Further, the post-processing station 306 may monitor the debinding and sintering process and provide feedback, e.g., to a smart phone or other remote device 312, about a status of the object, a time to completion, and other processing metrics and information. The post-processing station 306 may include a camera 314 or other monitoring device to provide feedback to the remote device 312, and may provide time lapse animation or the like to graphically show sintering on a compressed time scale. Post-processing may also or instead include finishing with heat, a hot knife, tools, or similar, and may include applying a finish coat.

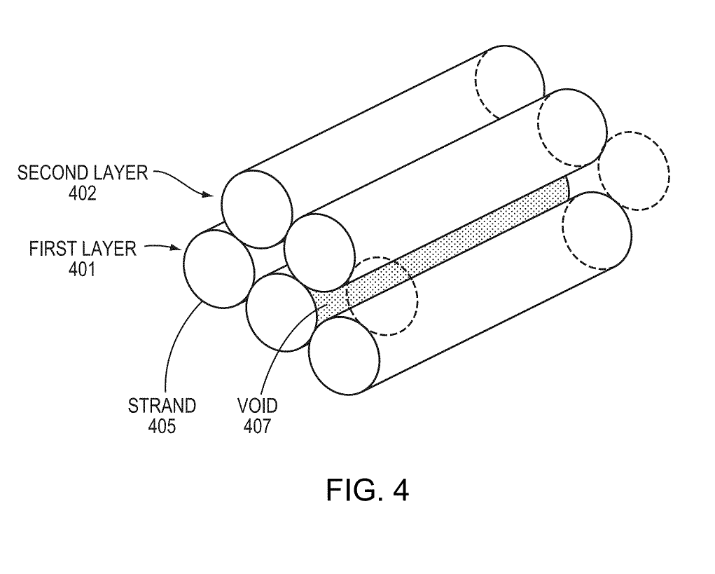

FIG. 4 is an isometric cross-section view of two layers 401, 402 printed by a 3D printer such as the printer 100 described above. Each layer 401, 402 comprises a number of lines (also referred to as a strand or track), such as line 405, that are deposited in succession by the printer. The geometry of each layer, and ultimately the resulting part, are defined by the combined geometries of all the printer toolpaths and associated extrusion parameters. Custom infill geometry is a chief advantage of layered manufacturing (LM) techniques such as fused deposition modeling (FDM). By modifying infill percentages, and thus deposition rates during the build, part density can be varied. However, minimization of part density comes at the expense of reduced mechanical properties. Conversely, to achieve isotropic mechanical properties, fully dense sections are required.

Conventional toolpath planning and extrusion rate control do not produce 100% dense sections while maintaining geometrical accuracy. As illustrated in FIG. 4, there can be voids between the strands. In many cases the highest possible density may be desired, and it may be highly desirable to reduce, minimize or eliminate voids as much as possible. At least for the reason that resulting internal pores can give rise to anisotropic material properties and therefore decrease part strength in at least one direction.

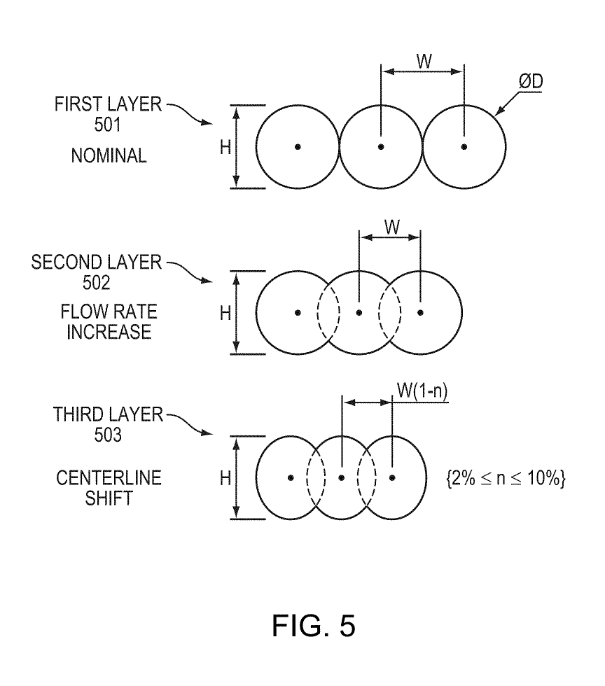

FIG. 5 is a front-cross section view of strand deposition in different configurations. The first layer 501 is printed under a nominal configuration, with a standard toolpath geometry and deposition rate to produce strands having a height H, width W, and diameter D. (While strands are herein illustrated having circularly cross-sectional shape it is noted that the technique is in no way limited to circular cross-sections and strands of various different cross-sectional shapes may be extruded and deposited. In general, even complex shapes can be regarded as having a strand height and a strand width.) In an effort to fill in voids and homogenize and improve material properties (such as increased density, elastic moduli, and several strengths), the printer may be controlled to a least attempt to print strands with an intentionally imposed excess of greater than 100% of the volume of the part (e.g., 102%). This can result in one or more of (i) excess extrudate distorting the shape of the part beyond the intended geometrical form, (ii) excess extrudate squeezing out and build up around the nozzle head, (iii) excess extrudate failing to extrude. For example, the second layer 502 can be printed in an over-extruding manner, which can result, at least in certain cases, in strands that fill a greater volume as compared to extrusion at the nominal rate. The third layer 503 is printed with a centerline shift (i.e., a toolpath width smaller than W) to space the lines closer together than the spacing as determined by the controlled line width, height, and diameter as shown in first layer 501, which can also result in a greater fill volume.

With ongoing reference to FIG. 5, while often challenging, commercial-grade machines may be controlled to achieve improved density by imposing a 2-3% shift in mean flow rate relative to the flow rate expected based upon the toolpath velocity and strand geometry. This increase in deposition rate can be applied globally, amongst all deposited strands, by modifications to appropriate parameters within the output toolpath that may include at least one of the rate of extrusion (extruding faster to overfill), strand geometry (using a fatter strand of increased diameter D and thus higher cross sectional area, e.g., an increase of w in FIG. 5), or relative speed between the extruder head and the build platform (to create a higher relative velocity thus causing overfill). These flow rate and toolpath modifications therefore can remain independent of the specific geometric form that may be printed.

Increased extrudate density within part geometry can be realized in different ways: For example, as illustrate din FIG. 5, the density of strands can be increased on a per-layer basis, or flow rate can be increased with respect to a given stage speed. Such methods of increasing part density can result in a reduction of geometric accuracy due to uncontrolled material deposition at boundary surfaces of the model. In such cases the over-extruded material may exceed the part boundaries. Furthermore, in this instances of increased extrudate density, extrudate may accumulate about the extrusion orifice and deposit irregularly throughout the 3D print once a critical mass has accumulated (also based on geometry and print speeds/accelerations). This non-deterministic deposition of excess material leads to poor dimensional accuracy, precision, and low geometric definition of small features.

In other words, density can be increased by increasing extrusion rate, or reducing spacing W to be less than width D, or both.

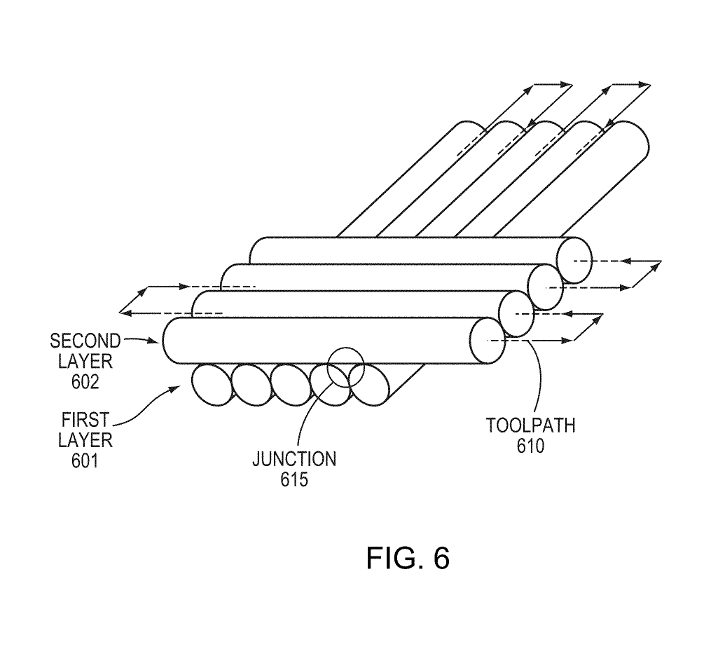

Drawing attention to FIG. 6 which illustrates another technique for improving density, a cross link deposition pattern with alternated oriented layers, on some occasions realized at various orientations including to but not limited 45 or 90 degrees, can provide for greater infill density by alternatingly filling concave sections that otherwise would have formed voids. FIG. 6 illustrates an example print, wherein a second layer 602 is printed, following a toolpath 610, above and perpendicular to a first layer 601, and the second layer 602 fills in junctions (e.g., junction 615) that extend into the first layer 601. This approach can reduce nominal volumetric error as-printed voids; therefore, required overfill volume is minimized.

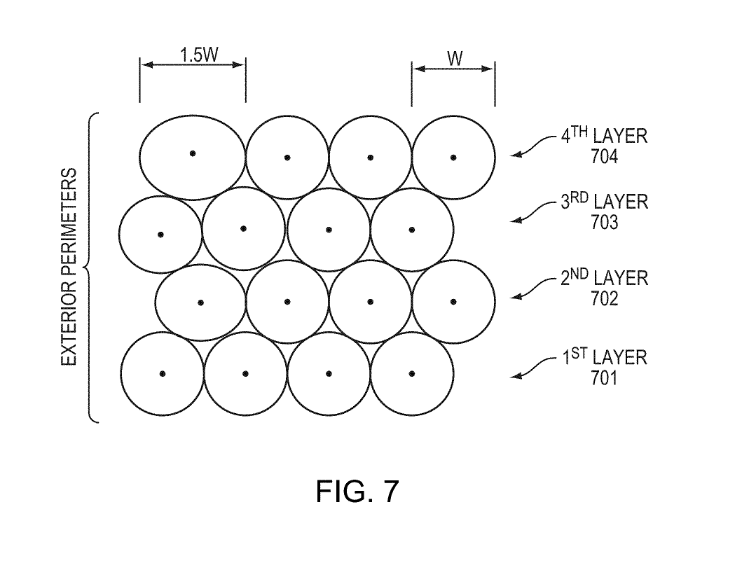

With reference to FIG. 7, density can be enhanced by varying strand width W throughout the several layers of the print. This approach serves both to maintain the geometric definition of the part at the part boundary and may also reduce the voidspace and increase the density. For example, in the first layer 701 the strands are deposited at a uniform strand width throughout and the second layer 702 contains an edge strand having a strand width that is a multiple 1.5 of the uniform size of the strands everywhere in 701. Such modulation of strand width producing these wide strands may serve to decrease the void space between the layers 702 and 701 by offsetting the strand centers of the uniform strands, which deposits strands of width w above the intersection of neighboring strands in the layer below. This same approach can be generalized to other regions of the print, for example the wide strand can also be varied within the bounding strands of a layer as a function of layer perimeter size/geometry (e.g., small features and corners). Moreover, the extrusion rate of exterior perimeter strands can be increased by 150%-200% on alternating layers to establish this condition visualized in FIG. 7.

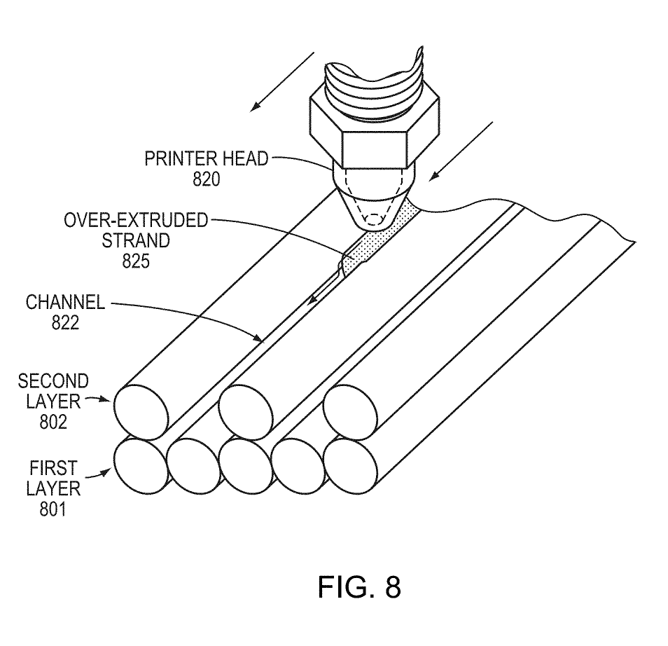

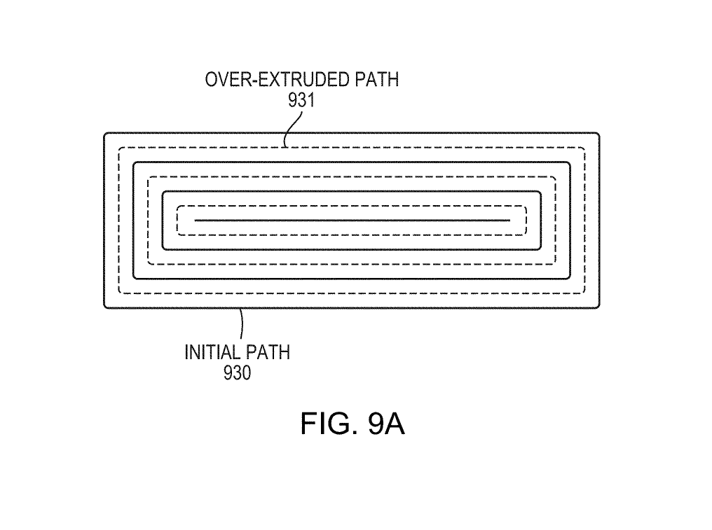

In reference to FIG. 8, the controllable print head may be configured to first deposit a plurality of strands of build material at a controllable strand width, strand height, and strand spacing. This strand spacing can be further controlled, as shown in FIG. 8, to form a channel (or gaps) of a defined gap width. While these first deposited strands, and channels formed between the deposited strands, are shown in the figure as oriented parallel to one another, the technique is not limited in this regard and in practice the orientation of the build strands and gaps between the build strands may assume relative orientations that are curvilinear, angular, or otherwise non-parallel. In general, however, it is preferred that the relative orientations between the deposited strands and gaps between the strands are arranged in a configuration which maintains a uniform gap width between nearest-neighboring strands of build material.

With ongoing reference to FIG. 8, the print head may be controlled to further deposit a set of filler strands within the gaps defined by the plurality of strands of build material. Depositing the filler strands in this operation can be highly advantageous and can be executed in a manner that leads to an increase in the density of the part formed by the printing operation, while also maintaining the geometric accuracy of the printed part. Moreover, the filler strands may be deposited at a rate of extrusion in which the amount of material intended to be deposited in the channel in any given window of time or distance along the print direction exceeds the volume of the channel in the same given window of time or distance. In other words, it is often desirable to attempt to deposit more material within the channel than there is space in the channel to accept. As has been described above, in various embodiments this can be executed as a tradeoff between print speed and extrusion velocity.

The abovementioned techniques in reference to FIG. 8 may also be executed with variations to the controllable deposition of the plurality of the first set of strands of build material and the second further set of filler strands of build material. In one embodiment, the first plurality of strands of build material may be deposited at a first temperature, and the second set of filler strands of build material may be deposited at a second temperature, where the second temperature may be the same or different than the first temperature. In practice, it is often advantageous to set the second temperature to exceed the first temperature by between 5 and 35 degrees Centigrade. This range is provided by way of example and should not be taken as a limitation of the described approach.

In another embodiment, still referring to FIG. 8, the first layer strand spacing and second layer strand spacing need not be identical. Depending upon the geometric configuration of the object to be printed, it may be desirable to modulate the strand spacing from layer to layer in order to arrive at the intended final dimension of the printed part. This construction may be required, for example, in instances where the width of the second layer of the part would require a non-integer number of first layer strand spacings to be produced to faithfully produce the intended dimensions of the second layer. Similarly, a mismatch of this sort may be addressed by varying the gap width from the first to the second layer, which may or may not be accompanied by variation in the strand width of the build material from the first to the second layer.

In further embodiments, in reference to FIG. 8, it may be advantageous in practice to print the strands in the first layer at a first strand height, and print the strands in the second layer at a second strand height that is different from the first. Concurrent with the variation of the strand height, it may be advantageous to vary the strand width to maintain an aspect ratio of the strands defined by the quotient of the strand height and strand width. This variation in aspect ratio may apply both to the plurality of build material strands and the set of filler strands of build material in concert, or to either of the plurality of build material strands or the set filler strands of build material individually. In general there can be various reasons for layer-to-layer variation in strand height, strand width, strand spacing . . . . The examples above are included here for purposes of clarification and are not to be conserved as being limiting.

In further embodiments, constraint channels can be printed at the nominal extrusion rate to act as fixed boundary conditions for “leading bulge” deposition. FIG. 8 illustrates an example print comprising first and second layers 801, 802. When printing the second layer 802, the print head 820 first prints alternating lines, leaving one or more channels (e.g., channel 822). The print head 820 may then, in a second pass, deposit an over-extruded line 825 into the channel 822. The boundaries of the channel 822 established by the previously-printed lines may guide the material of the over-extruded line 825 to fill in a greater portion of the channel, including the voids between the previously printed lines in the first and second layers 801, 802.

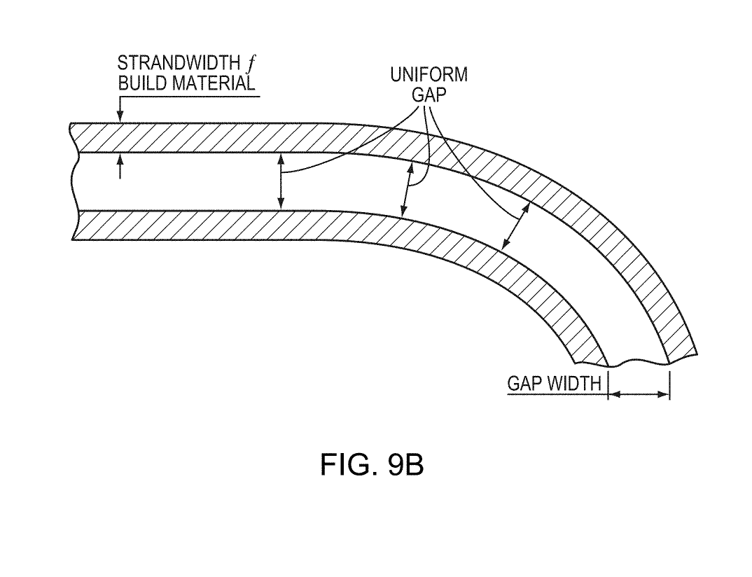

FIG. 9A is a schematic diagram representing a top-down view of a set of toolpaths that may be implemented in the approach of FIG. 8. An initial path 930 comprised of a first plurality of strands of build material is shown as solid lines and is deposited first, while a subsequent, over-extruded path 932 comprised of a second set of filler strands of build material is shown as dotted lines occupying the channels between the initial path 930. Such a toolpath configuration may be adapted for some or all layers of a printed object. Note that this schematic illustration renders the paths taken in the deposition of the first plurality of strands of build material and the second set of filler strands of build material, and does not capture the relative strand widths of each set which may, in practice, vary depending upon the geometry and/or the specific embodiment of the printing method.

FIG. 9B is a top-down view of a set of toolpaths showing a schematic diagram of a first set of build material configured cuvilinearly and offset to one another by a uniform gap. This is one such example configuration of the first set of build material. Such a configuration may exist in this state for a first portion of a deposition during a print operation, and then proceed in a parallel configuration for a second portion of a print operation.

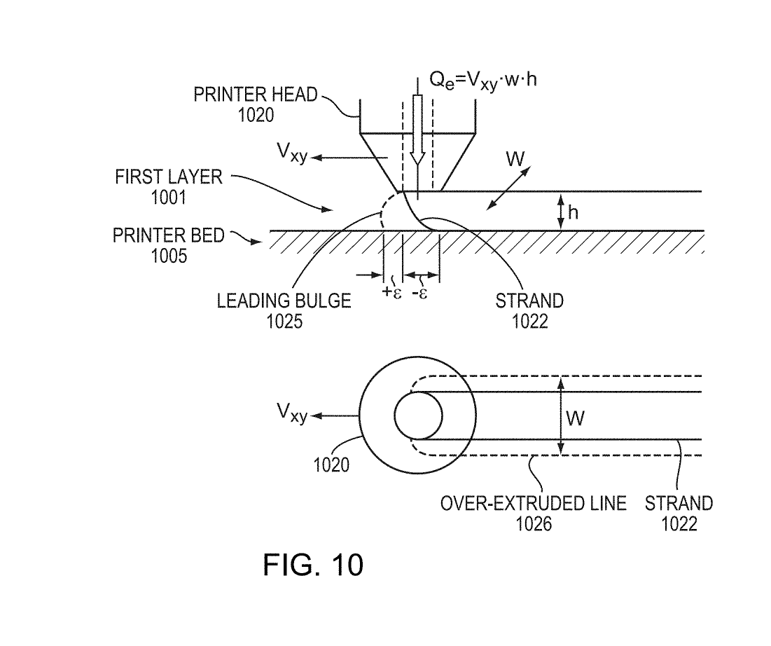

FIG. 10 presents a side and top-down view of an in-process deposition of a strand. During a typical deposition of a strand, the printer head 1020 deposits a strand 1022 of a first layer 1001 at a height h from the build surface 1005 while moving laterally at a velocity Vxy. As shown in the side view, the leading edge of the line 1022 curves and falls behind the printer head 1020 as the printer head moves forward. Furthermore, as shown in the top view, the strand width in the case of typical deposition of a strand is smaller as compared to the over-extruded strand width.

One method to produce a “leading bulge” as described above with reference to FIG. 8, the printer may first begin extruding material before the printer head 1020 begins to move, thereby developing the leading bulge 1025 as shown. The leading bulge 1025 may enable additional pressure on the deposited material of the strand 1022, thereby improving flow of the material into a channel (e.g., channel 822 and the crevasse between lines therein). Moreover, this approach can be realized in situations where only a single boundary of a channel exists. Further, the printer may operate in an over-extrusion mode, whereby the flow rate Qe through the printer head 1020 is increased to exceed the nominal value given by the product of the lateral velocity Vxy and the strand height h and the intended strand width w.

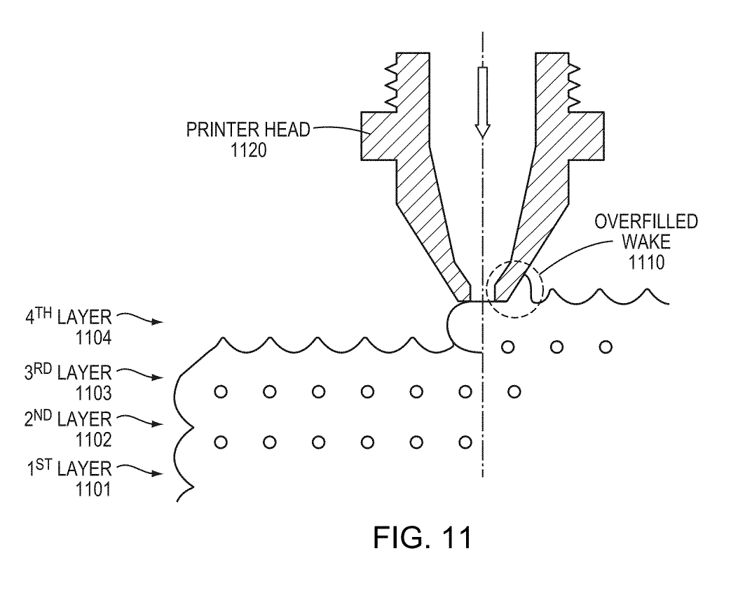

FIG. 11 is a cross-section of a print in a further embodiment, wherein a printer head 1120 is printing a fourth layer 1104 atop three previous layers 1101-1103. The material deposition rate Qe can be varied in a cyclic manner about the mean flow rate. An initially large flow rate sufficient to produce over extrusion (105-110%, relative to the product of the print head speed and the anticipated strand height and strand width) can be used to establish an overfilled wake 1110 through which the successive layers are printed. The flow rate can then be decreased when cumulative overfill volume surpasses a threshold based on layer cross sectional area (minimizing nozzle accumulation). The cross-sectional strand density (i.e., the number of strands counted in any area pass through the plane defined as normal to the print direction divided by the total area) can be increased as a function of layer perimeter size and/or geometry (e.g., to accommodate small features/corners). Further, the flow rate can be increased when cumulative overfill volume goes below a threshold based on layer cross sectional area, which avoids under-filling, whilst also maximizing part density. Wake height amplitude (e.g., overfill volume) can be measured using an onboard measurement device during printing. This volumetric measurement can be used as a control parameter to sustain an optimum overfill. Such measurements can be used to control the increased flow rate described above, and such control can be independent of overall part geometry. A combination of extrusion rate control and toolpath optimizations can be used to minimize accumulation during overfill.

In further embodiments, material not forming the desired part structure can be removed from the as-printed structure, which can be over-filled. The accumulated mass can be solidified on an extraction tool and later removed. The extraction tool can be mounted on the extruder assembly or, alternatively, a separate assembly. An apparatus external to the build volume can be used to remove accumulation. Alternatively, an apparatus internal to the print volume, or a combination of apparatuses, can be used to capture nozzle accumulation. For example, the nozzle of the printer head can be cooled using a fan, and the nozzle can move to a location within the printer intended to accept the accumulated material. In some realizations of the embodiment, this may be a “dump bucket” or other receptacle designed to capture accumulated material. The nozzle can then be reheated to remelt the material, and a mechanically-assisted wipe can be used to remove accumulation from the build volume. Further, large fluxes of material through the nozzle may be anticipated. In response, the heating rate may be adjusted in advance of the increased deposition rate to ensure that the build material remains melted and extrusion is not limited by heating.

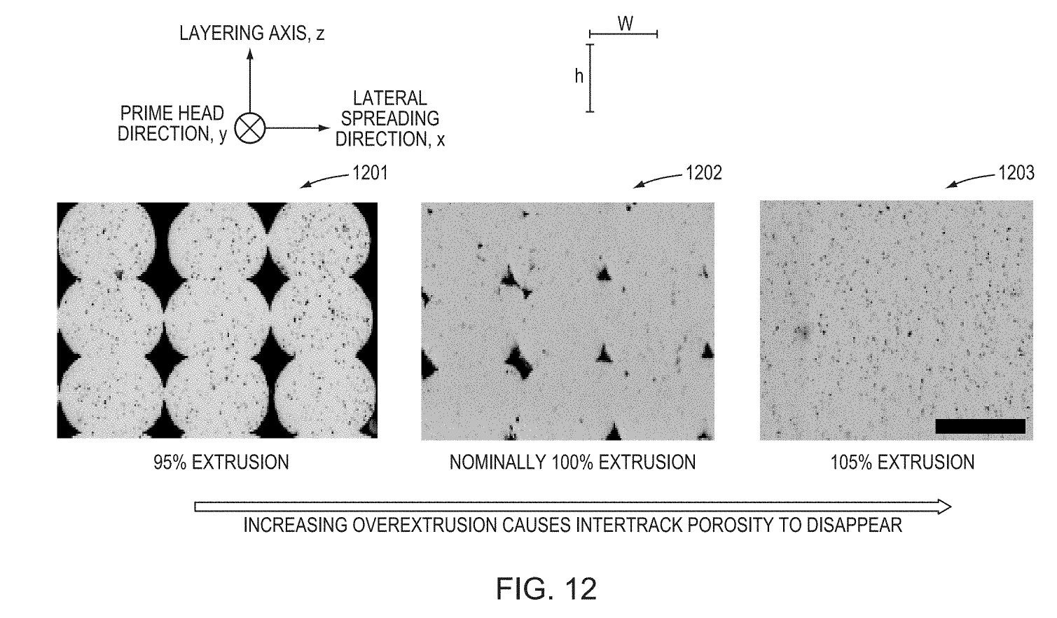

FIG. 12 is a cross-section illustrating printed strands a varying extrusion rates relative to the intended volume of the object being printed. A first view 1201 illustrates a processed print at 95% extrusion; a second view 1202 illustrates a processed print at nominally 100% extrusion; and a third view illustrates a processed print at 105% extrusion. The processing here was required to adequately section and visualize the strands in the current configuration. In extrusion-based 3D printing techniques (often referred to within as metal fused filament (MFF), fused filament fabrication (FFF), fused deposition modeling (FDM), or bound metal deposition (BMD)), individual strands, segments of strands, and curves are extruded through a nozzle which moves relative to a build plate to accomplish the formation of a three-dimensional object. In order to achieve high strength and other mechanical properties (relative to the wrought form of the material, in the case of metals) for the chosen build material, it is desired that the printed part exhibit minimal porosity.

Porosity is introduced during the printing of individual strands, segments of strands, and curves at the intersection and contact of the various strands. Colloquially, these regions of porosity are referred to as “FDM diamonds” as the exhibit a diamond-like profile when a part is cross-sectioned perpendicular to the print direction. The presence of tool-path induced porosity is generally independent of the bound metal during printing.

The problem of extrusion-related porosity in 3D printed parts produced by material extrusion. As described in previously, extruding extra material, often termed overextrusion, can mitigate the presence of toolpath-induced porosity, but can also be accompanied by undesirable side-effects. In some approaches, the way fully filled parts were constructed was that more material was deposited in each layer than the actual volume of the layer—that is, if a layer contained 100 volumetric units of material, 102 volumetric units of material would be deposited nominally uniformly throughout the layer. In essence, >100% of the required flow volumetrically is deposited everywhere. While this is effective in creating fully-filled parts because extra material is being forced in everywhere, this over-extrusion of material results in extra material spilling out of the sides of parts that is detrimental to tolerances, and extra material accumulating on the tops of parts that eventually causes printing failures as the printer head eventually starts ‘printing below the surface of the part.’ Overextrusion is essentially a brute force method of printing that does not scale to big parts because of the side-effect of material buildup.

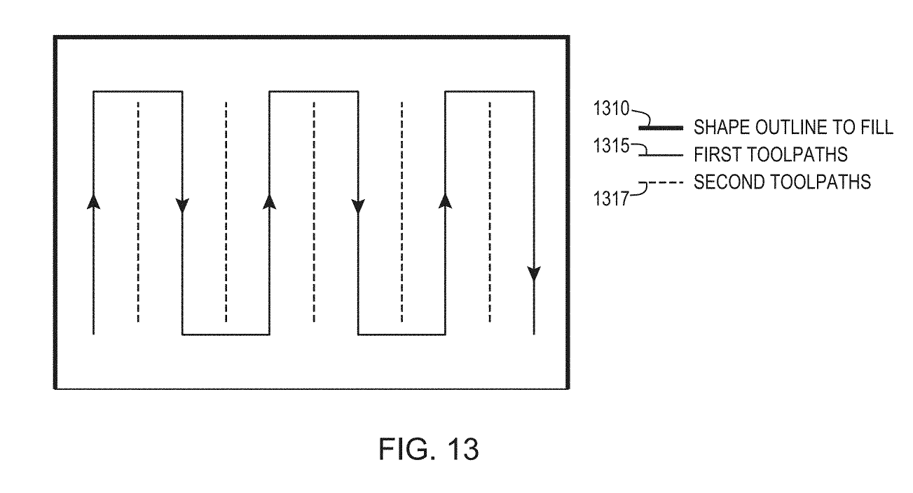

FIG. 13 is a top-down view of a set of toolpaths in an example embodiment, building upon embodiments previously described. In this embodiment, a set of at least two print strands are created within the layer boundary 1310: a first continuous strand of build material 1315, which can be printed first, and a second set of filler strands of build material 1317. The first continuous strand of build material or set of strands of build material 1315 establish a boundary. The area inside of this boundary defines a region which may be utilized for a second set of filler strands of build material 1317 to be extruded. Arrows illustrate one set of possible directions for the print head to move relative to the build surface. As shown, the lines of the second toolpaths are substantially contained within ‘channels’ created by the first toolpath. In further embodiments, the first and second toolpaths may define patterns other than the alternating and offset parallel lines as shown. For example, and as described above, the first and second toolpaths may define curved lines or other geometric patterns, wherein the first toolpath defines channels between the toolpath to be occupied by the second toolpath. Additional toolpaths having one or more different line types may also be implemented in combination with the first and second toolpaths.

In this embodiment of, the rate of extrusion of the several strands of build material may be the same or different. The programmed dimension of the deposited strand geometry along the toolpath may be the same or different, both between and among the several toolpaths. The rate of extrusion of the first set of strands of build material is typically controlled and deterministic. The rate of extrusion of the second set of filler strands of said build may or may not be controlled. By way of example, the deposition of the first plurality of strands of build material may be deposited at a rate of extrusion to produce a set strands having strand widths and strand heights everywhere along the strand, whereas the second set of filler strands of build material may now be extruded without control as the second strand geometry is now substantially defined by the existing first set of strands of build material. Further embodiments may also include a control approach where the rate of extrusion is not controlled continuously at all rates of extrusion, but is instead limited to not exceed a first certain rate of extrusion, or is limited to not to decrease below a second certain rate of extrusion. Moreover, other example embodiments may employ two or more different line types in a print, each of the line types exhibiting different parameters such as track width, temperature, flow rate and/or type of build material.

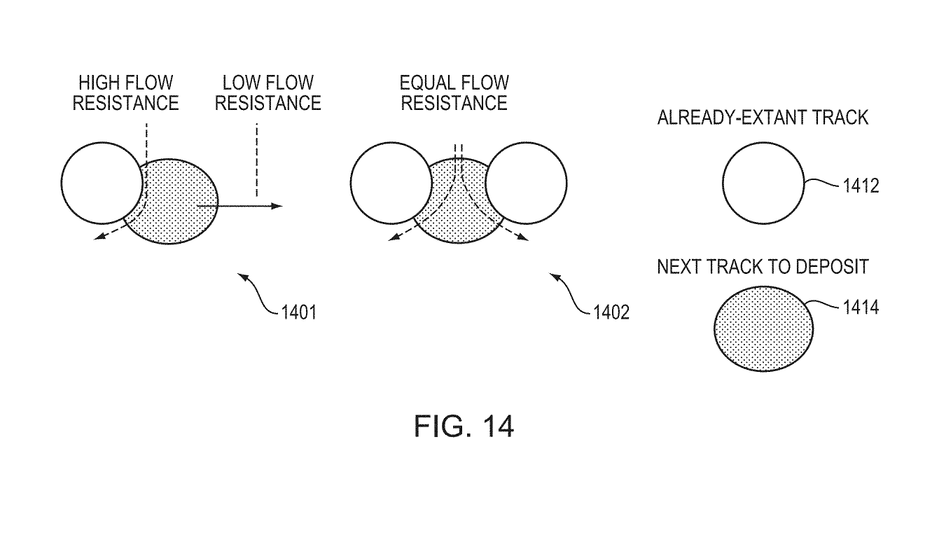

FIG. 14 is a side view of a deposition, illustrating one set of first strands that create channels/walls that constrain the material deposited in a set of second strands. As shown in view 1401, an already-extant strand 1412 provides high flow resistance to a second strand 1414 to be deposited. Without another strand opposite of the second strand 1414, the second strand 1414 faces low flow resistance to the right when deposited, resulting in uneven flow strand deposition about the center of the print head depositing the strand. In contrast view 1402 illustrates two extant strands 1412 creating a channel that constrains the second strand 1414 on both sides, thereby providing equal flow resistance at each side of the second strand 1414 as it is being deposited, enabling even flow of the deposited strand of build material. This high and even flow resistance can increase the filling of the diamond-shaped voids created between the extant strand and the next strand to be deposited.

Further, the temperature of extrusion of the second strand or set of strands of build material (or filler strands of build material) may be different than the first plurality of strands of build material. The purpose here is to print the material at a higher temperature in order to decrease the resistance to flow of the material being printed so that it may more easily fill small regions created by the layers already printed. A higher temperature will also delay the solidification of the extruded material due to the longer time needed for heat extraction. This may allow the second further set of filler strands of build material increased time to flow into the channel relative to the same condition at a lower temperature, and may more effectively partially re-melt the material deposited during prior toolpaths, yielding better filling and joining at a microscopic level, relative to the same process at a lower temperature.

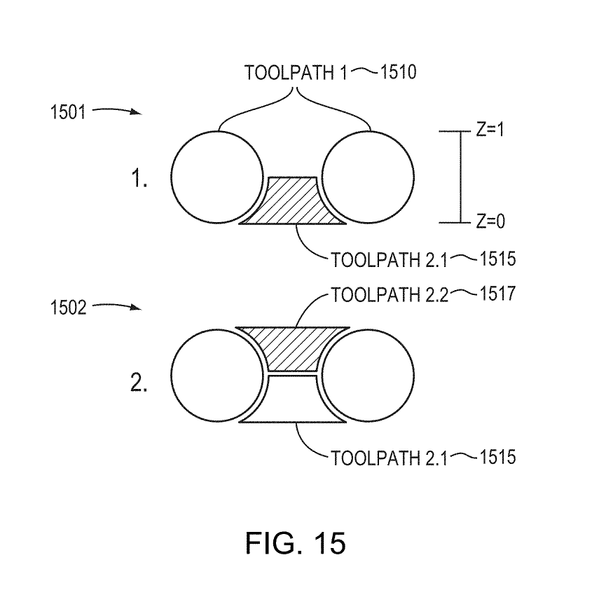

FIG. 15 illustrates a print in a further example. This approach may be comparable to the that of FIGS. 13 and 14, but instead of the second set of strands being deposited in a single operation (toolpath 2) to bring the height of the second set of strands to an equivalent height H1 on level with the first set of strands of build material printed at height H1 (toolpath 1), the second set of strands of build material is deposited in at least two operations. The at least two operations print the second set of build material to a net strand height of H2 equal to the first strand height H1. In the illustration provided in FIG. 15, this operation is shown to occur sequentially in two steps (1515, 1517), whereas in practice it may be realized in more than two steps. Regardless of the number of steps, the x/y coordinates of toolpath 2 are followed, but the strand height of the particular strand is less than that of the first strand height. The sum of strand heights from all of the second operation strands may or may not be equal to the strand height of the toolpath 1 strands. Toolpath 1 1510 creates the constraining beads, which have a z height of 1. The first toolpath 2 (2.1), depositing the line 1515 at a first pass as shown in view 1501, has an approximate height of 0.5, half of the toolpath one height. The second toolpath 2 (2.2) depositing the line 1517 at a second pass as shown in view 1501, deposits on top of the first toolpath 2 (2.1) but at a Z height of 1.

By decreasing the Z height of the toolpath 2.1, the x/y dimensions between the toolpath 1 strands is decreased, creating more of a constrained region. The constrained region may encourage the flow of material into the diamond areas, leading to higher density fill.

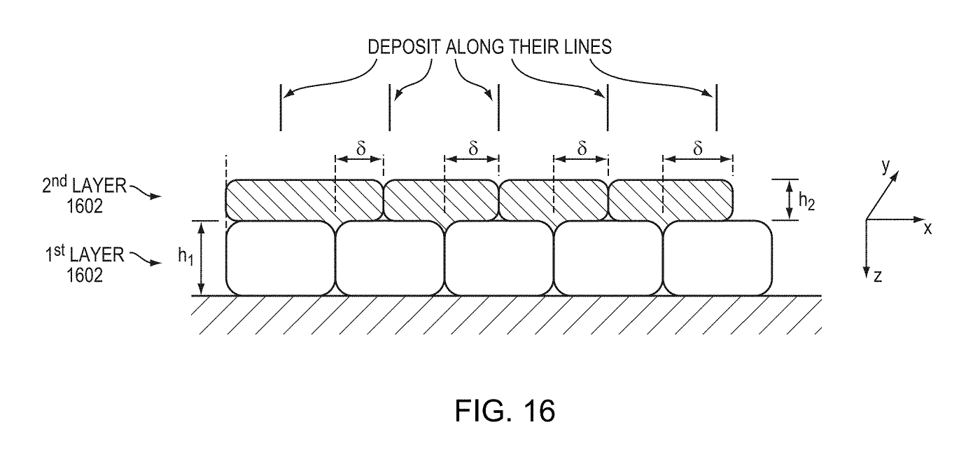

FIG. 16 illustrates a print in a further embodiment. Here, strand heights are periodically varied within a print. The toolpath in the plane of printing remains unmodified, but there is a uniform offset relative to the already printed surface. Typically, parts are printed with a uniform layer height throughout the entire print. For example, as shown in FIG. 16 layers 1601 and 1602 may be printed at different height (e.g., H1 and H2), while keeping the flow rate per speed of the nozzle the same in each layer. This will result in over-extrusion of every other layer to fill voids left in the layer at full height.

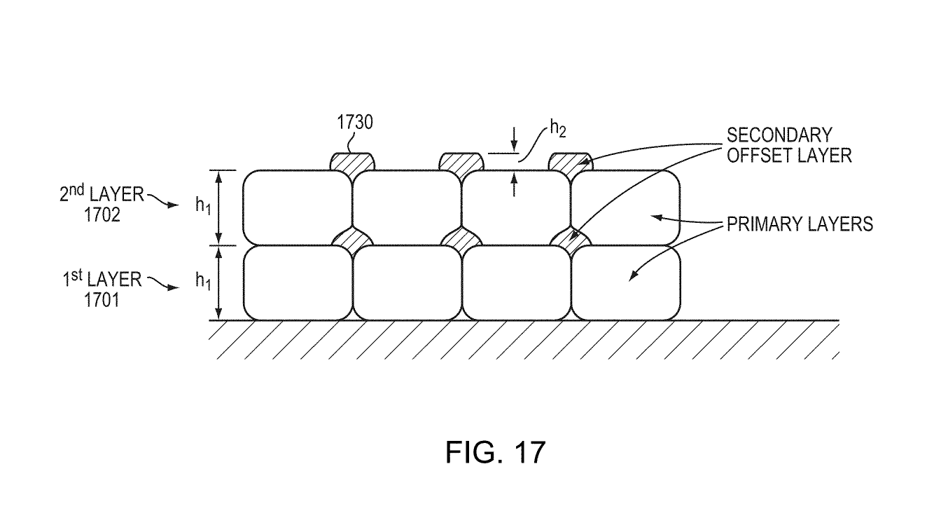

FIG. 17 illustrates a print in a further embodiment. Here, intermediate strands (e.g., line 1730) may be deposited with a decreased flow rate command (or pressure command) and at a strand height different than the primary strands 1701, 1702. The material in the secondary offset strands may be deposited in such a manner that it fills the diamonds from the layer prior and generally decreases porosity upon deposition for the next layer.

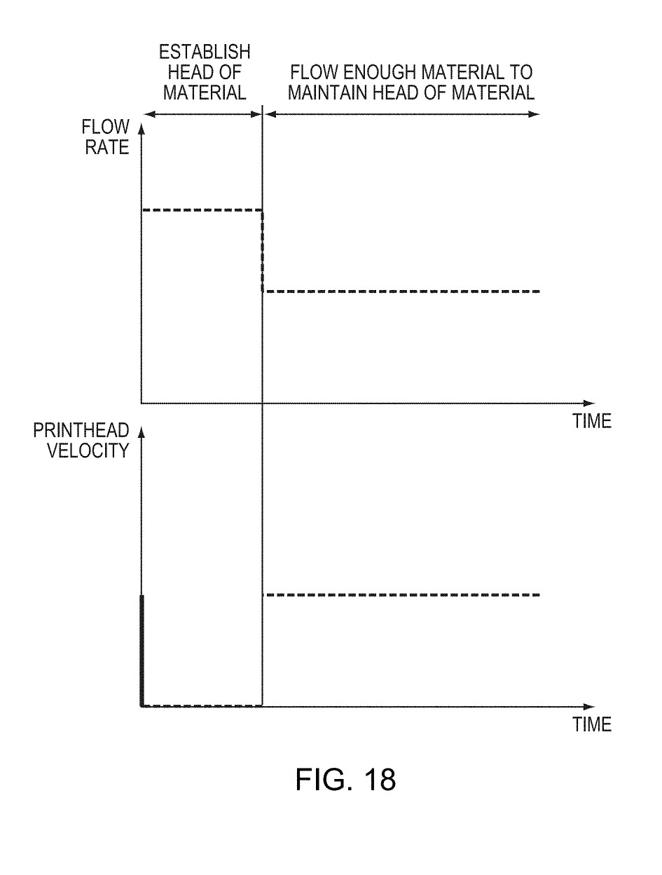

FIG. 18 is a timing diagram illustrating operation of a printer in example embodiments. In order for a fully-filled part to be produced, the resistance for filling of diamonds may be comparable to or less than the resistance for any other lateral/vertical flow paths the material might take. These flow paths can be perpendicular to the toolpath direction and within the printing plane, as shown in FIG. 14, ahead of the print head within the printing plane (that is, flow along the toolpath direction within the printing plane), or even or of the printing plane, via material flowing around the nozzle and vertically upward.

Instead of overextruding uniformly throughout the part, which can result in material buildup and loss of geometrical accuracy and definition, toolpathing and configurable extrude commands along the toolpath may be configured to overextrude at certain locations along the toolpath such as the beginning of a line segment or other areas to promote increased pressure where sufficient amounts of material has not yet been built up, with the purpose of supplying a head of extra material needed to fill the diamonds (FIGS. 8 and 9). After building up this initial extra head of material, the printer may be further configured to modulate the rate of extrusion to maintain this head of material, and prevent further buildup. One such example embodiment is shown in FIG. 18. The flow rate needed to maintain a given head of material may be a function of the geometry of the adjacent material present, and thus that the flow rate will be adjusted to maintain this head of material as the printer head encounters these local geometries of flow.

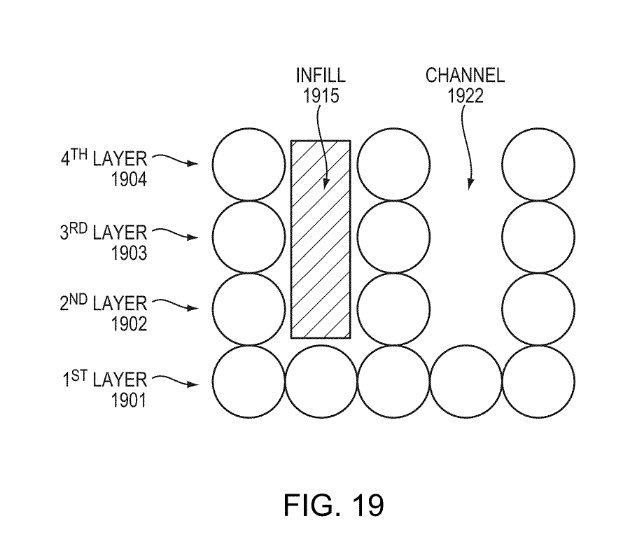

FIG. 19 illustrates a cross-section of a print in a further embodiment. The print may be comparable to embodiments described above with reference to FIGS. 8, 13 and 14, but comprises channels (e.g., channel 1922) having a height equal to multiple layers. The first toolpath creates a first layer 1901, and then creates the constraining channels by building up successive, stacked strands in subsequent layers 1902-1904. The second toolpath may be executed in the same Z height or less of the first toolpath. In this embodiment, the second toolpath can be executed with Z height greater than the first toolpath. With this approach, the first toolpath can create either a channel or “deposition receptacle” of various size and geometry. These “deposition receptacle” can alternate in X, Y and Z direction. In this approach at a determined height, the second toolpath would be a toolhead move over a “deposition receptacle” and an extrusion until the “deposition receptacle” is filled to the top. Extruding continuously into a single spot may lead to a longer duration of the build material above any given target temperature, the any given target temperature beneficial to improve flow into regions of low hydraulic conductivity. This approach should also lead to better z strength. A multitude of materials could be deposited into these buckets including low viscosity, highly filled material or a solid component with a set shape. For example, several 6mm cylindrical cavities may be formed, and a rod may then be inserted into them via an automated process.

In order to achieve higher-density printed object, various approaches can be implemented in both hardware configurations and control configurations. A number of those approaches are described below.

Central to the performance of the toolpathing described above are control systems and methods to produce fully-dense parts while preserving reliability and performance of the extruder in separate regions of operation. One challenge here is establishing operational parameters for, by way of example: (1) the extruder in depositing a first plurality of strands of a build material and a second set of filler strands of build material, (2) both the first and second build path or set of paths in toolpath 1 with reference to toolpath strategies with multiple toolpaths, as the second build path will require a higher force of extrusion as compared to the first build path where the material printed is relatively unconfined, (3) other toolpaths printing at least one strand of build material.

A first method entails controlling motor torque, and therefore the force exerted on the extruded build material. The motor torque may be controlled, for example, via current control at a driver board, where the motor force is varied to maintain a force below a force causing failure of the material. Motor torque may be increased when extruding to fill a channel. To achieve protection of the extruder with robust overfilling, the force and torque on the extruder can be limited to an amount slightly below the maximum force as defined by that which will damage the extruder hardware, the extruded build material within the extruder, or any combination thereof. In the current configuration of the extruder, this is a buckling and plastic deformation limit imposed by the interaction of the actuator and rod-shaped feedstock. For motor-driven extruders, a current limit can be reliably programmed in the motor drivers to accomplish limiting the applied torque from the motor, and therefore limiting the force applied by the extruder to flow material.

A second method includes directly transducing extrusion pressure, and using this measurement to assure complete filling of parts. The pressure may be detected from a pressure sensor at the printer head or another location, and the sensor may provide input to a control loop configured to limit the pressure. While the force applied by the extruder in its drive mechanism is a measure of how much pressure is generated to flow the material during extrusion, the force is generally only an approximation for the pressure. The pressure drop from the liquefier to the atmosphere in the print chamber is the parameter which truly dictates material flow rate through the extrusion nozzle portion of the print head. The motor torque/force applied by the motor are imperfect surrogates for this pressure drop because other factors, such as internal friction in the drive mechanism, may increase the torque required for extrusion without leading to an increased material flow rate. In some instances, it is thus useful to directly measure the pressure drop associated with the extrusion process instead of torque.

In more detail, while failure of the extrusion hardware imposes an upper bound on the force which can be generated to provide extrusion, a lower bound on the force needed to get full part filling is imposed by the estimated pressure required to completely fill the FDM diamonds. This pressure is a function of the geometry of the prior toolpath to be filled and the rate at which the filling is to occur, but can generally be known ahead of time owing, for example to the deterministic nature of toolpathing, such that one may command a pressure drop to be applied to the extruder at all points in the toolpath in order to assure that all extrusion-related voids are substantially filled or eliminated. The above two methods should allow closed-loop control of the extrusion forces during processing such that parts are fully-filled.

A third method includes using pre-programmed, or assigned, or already known aspects, or a combination thereof, of knowledge of the bead geometries in order to fully fill parts. For a given geometry that must be filled with material, the resistance of this geometry with respect to filling of diamonds is in my cases deterministic, and should therefore require a fixed amount of material to be extruded in that region in order to fill the diamonds. A reference table, indicating geometries, material composition, and/or control comments (e.g., pressure, torque, extrusion rate) may be utilized. Note that the material that must be extruded is not necessarily equal to the total volume desired to be filled, but may generally be greater or less than the total nominal volume to be filled depending on the details of the geometry and its flow resistances, along with prior over- or under-extrusion of material. The approach then will limit the commanded flow rate with a knowledge of the resistance required outside of the nozzle. In contrast to the first two approaches, this is open-loop and is less robust.

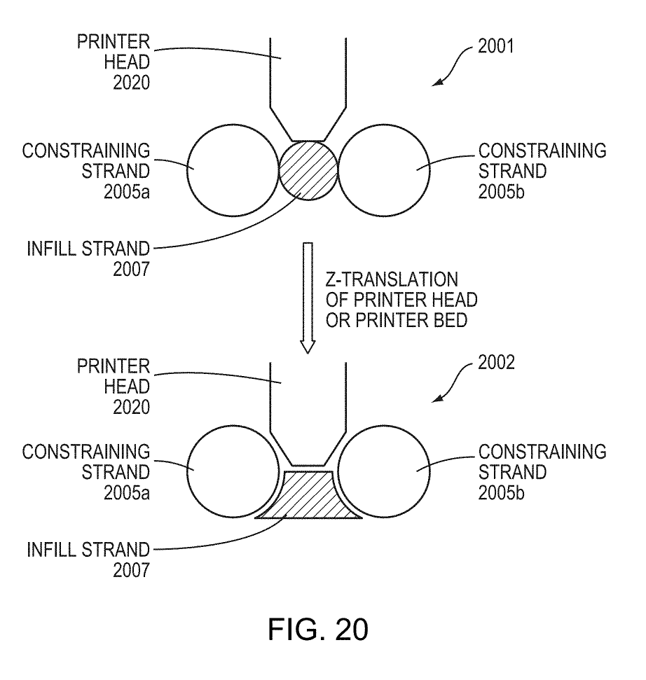

FIG. 20 illustrates a method of printing to provide a compressed strand of build material within a channel. In some approaches, pressures are derived and limited by the feeding mechanism and/or pump. This is true as well in injection molding, particularly for thin features (which is a translatable problem). To overcome this limitation, large scale methods utilize compression injection molding where the pump first creates a charge in a semi-open mold. Next, the mold and outer components of the pump clamp together, forcing the charge to fill all features. In this method for 3D printing, this compression force may be delivered either by a pecking (z) movement of the extruder and/or the build platform as long as the distance between the two at the start is greater than the distance at the end. This approach may be utilized while the tool head moves in the x/y plane or when it is static.

As shown in the first view 2001, the printer head 2020 first deposits an infill strand 2007 between two previously-printed constraining strands 2005a-b. Next, in the second view 2002, following z-translation of the printer head 2020 or printer bed, the printer head 2020 extends into the channel, compressing the infill strand 2007 to fill a bottom portion of the channel, including the gaps under each of the constraining strands 2005a-b. The printer head 2020 can apply this compression in a number of different ways. For example, the printer head 2020 may print the infill strand 2007 in a first pass at a height as shown in view 2001, transition to the height as shown in view 2002, and perform a second pass along the channel to compress the infill strand 2007. Alternatively, the printer head 2020 may periodically transition between the two heights while printing the infill strand 2007, or may maintain the height in view 2002 during the entire print, thereby printing and compressing the infill strand 2007 in a single pass.

A goal of this approach may be to deliver additional pressure to material to fill constrained regions while not compromising the mechanics of the rod or pre-extruder material. The application of the pressure may occur though the motion of the extrusion head perpendicular to the plane of printing. The pressure may be applied through the relative motion of the printed part and the extrusion head, and this motion may depend generally upon the previously-printed geometry, geometry to be printed, print temperature, temperature of the build volume, and specific flow characteristics of the material being deposited.

The systems, devices, methods, processes, and the like described herein may be realized in hardware, software, or any combination of these suitable for a particular application. The hardware may include a general-purpose computer and/or dedicated computing device. This includes realization in one or more microprocessors, microcontrollers, embedded microcontrollers, programmable digital signal processors or other programmable devices or processing circuitry, along with internal and/or external memory. This may also, or instead, include one or more application specific integrated circuits, programmable gate arrays, programmable array logic components, or any other device or devices that may be configured to process electronic signals. Further, a realization of the processes or devices described above may include computer-executable code created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software. In another aspect, the methods may be embodied in systems that perform the steps thereof, and may be distributed across devices in a number of ways. At the same time, processing may be distributed across devices such as the various systems described above, or all of the functionality may be integrated into a dedicated, standalone device or other hardware. In another aspect, means for performing the steps associated with the processes described above may include any of the hardware and/or software described above.

While this invention has been particularly shown and described with references to example embodiments thereof, it will be understood by those skilled in the art that various changes in form and details may be made therein without departing from the scope of the invention encompassed by the appended claims.

1. A method of printing an object, comprising:
printing strands of build material at a controlled rate of effluence from a print head that moves at a speed and direction relative to a build surface;
depositing a first set of strands of a build material at a set of strand-widths and strand-heights, a local print direction defining the local strand position and being substantially locally parallel between adjacently deposited strands of the first set, gaps between the first set of strands having a set of gap widths; and
depositing a second set of filler strands of the build material, the second set of filler strands deposited with a second set of filler strand-heights, and having a second set of filler strand-widths sufficiently wide to cause the second set of filler strands of the build material to substantially fill the gaps between the first set of strands.

2. The method of claim 1, further comprising depositing the plurality of the first set of strands of build material at a first temperature of the build material, and depositing the second set of filler strands of the build material at a second temperature of the build material different than the first temperature of the build material.

3. The method of claim 1, further comprising depositing the plurality of the first set of parallel strands of build material at a first ratio of a rate of effluence to the product of the strand width and strand height and relative speed, and depositing the plurality of the second set of filler strands at a second ratio of a rate of effluence to the product of the strand width and strand height and relative speed, wherein the ratio for the first set of parallel strands is substantially different than the ratio for the second set of filler strands.

4. The method of claim 1, further comprising depositing the plurality of the first set of parallel strands of build material at a first speed relative to the build surface, and depositing the plurality of the second set of filler strands at a second speed relative to the build surface, where the second speed relative to the build surface is substantially different than the first speed relative to the build surface.

5. The method of claim 1, further comprising depositing the first set of parallel strands of build material at a first strand width, and depositing the second set of filler strands of the build material at a second strand width, where the first strand width is substantially different than the first strand width.

6. The method of claim 1, further comprising depositing the plurality of the first set of parallel strands of build material at a first strand height, and depositing the second set of filler strands of the build material at a second strand height, where the first strand height is substantially different than the first strand height.

7. The method of claim 1, wherein the first set of strand heights and second set of strand heights are substantially equal.

8. The method of claim 1, wherein each of the set of second strand widths is approximately equal to the width of corresponding gap in which each second strand is deposited.

9. The method of claim 1, wherein the widths of the set of second strand widths are within 5% of the widths of the gaps.

10. The method of claim 1, wherein the widths of the set of second strand widths are within 1% of the widths of the gaps.

11. A method of printing an object, comprising:
printing strands of build material at a controlled rate of effluence from a print head that moves at a speed and direction relative to a build surface;
printing a first plurality of substantially locally parallel strands from a build material in a first layer of a printed object, the plurality of strands positioned adjacent to one another and having a first set of strand widths; and
printing a second plurality of substantially locally parallel strands from the build material in a second layer of the printed object, each of the strands from the second plurality of strands covering from above a connection point between two of the first plurality of strands.

12. The method of claim 11, further comprising printing an edge strand in an adjacent layer, the edge strand occupying an edge portion of the adjacent layer of the object, the edge line having a width substantially larger than the uniform width of each of the second plurality of parallel lines.

13. The method of claim 11, further comprising printing an edge strandline in an adjacent layer, the edge strand occupying an edge portion of the adjacent layer of the object, the edge line having a width substantially smaller than the uniform width of each of the second plurality of parallel lines.

14. The method of claim 11, wherein the uniform width of the second plurality of strands is less than the uniform width of the first plurality of strands.

15. The method of claim 11, further comprising printing a third plurality of strands in a third layer of the printed object, a vertical distance between the first and second layer being distinct from the vertical distance between the second and third layer.

16. A method of printing an object, comprising:
printing strands of build material at a controlled rate of effluence from a print head that moves at a speed and direction relative to a build surface, said strands of a build material exhibiting a predetermined set of strand-widths and strand-heights, printing a first layer of a printed object at a first ratio of the rate of effluence to the product of the build speed and strand height and strand width;
printing a second layer of a printed object at a second ratio of the rate of effluence to the product of the build speed and strand height and strand width, the second ratio being greater than the first ratio determining accumulation of build material at a print head concurrently with printing the second layer;
comparing the accumulation against a threshold; and
and removing the build material from the print head in response to the accumulation surpassing the threshold.

17. A method of printing an object, comprising:
depositing material from a print head at a deposition rate, the deposition rate selected to yield a controllable accumulation of material on the print head during the deposition process;
determining accumulation of build material at a print head concurrently with material deposition;
comparing the accumulation against a threshold; and
removing the build material from the print head in response to the accumulation surpassing the threshold.

18. A method of printing an object, comprising:
depositing strands of build material at a controlled rate of effluence from a print head which moves at a speed and direction relative to a build surface;
printing a first layer of an object from a plurality of first strands having a strand width and strand height, the first layer having a first height equal to the first strand height, the first layer having a first extrusion ratio given by a first rate of effluence over the product of the first deposition speed and first strand height and first strand width; and
printing a second layer of the object from a plurality of second strands having a second strand width and second strand height, the second layer having a second extrusion ratio given by the second rate of effluence over the product of the second deposition speed and second strand height and second strand width, the second layer having a second height equal to the second strand height.

19. The method of claim 18, wherein printing the first and second layers includes printing the first and second layers at an equal extrusion ratio.

20. The method of claim 18, wherein printing the second layer includes printing the plurality of second strands such that the vectors describing the first and second strands are substantially offset from one another in the plane of the layering axis.

21. The method of claim 18, wherein depositing the second layer includes printing the second layer at a second extrusion ratio less than the first extrusion ratio.

22. The method of claim 21, wherein printing the second layer includes printing lines of the second layer centered on edges of printed lines of the first layer.
